(19) United States
(12) Patent Application Publication
(10) Pub. No.: US 2006/0226404 A1
(43) Pub. Date: Oct. 12, 2006

(54) Stabilized flame retardant

(75) Inventors: Harald Bauer, Sulzbach (DE); Frank Eisentraeger, Sulzbach (DE); Sebastian Hoerold, Sulzbach (DE); Werner Krause, Sulzbach (DE)

Correspondence Address: CLARIANT CORPORATION;INTELLECTUAL PROPERTY DEPARTMENT, 4000 MONROE ROAD, CHARLOTTE, NC, 28205, US

(73) Assignee: CLARIANT Produkte (Deutschland) GmbH

(21) Appl. No.: 11/399,982

(22) Filed: Apr. 7, 2006

(30) Foreign Application Priority Data
Apr. 8, 2005 (DE) 10 2005 016 195.2

(51) Int. Cl. C09K 21/00

(52) U.S. Cl. 252/601

(57) ABSTRACT

The invention relates to a stabilized flame retardant comprising a) from 99 to 1% by weight of melamine polyphosphate b) from 1 to 99% by weight of additive with latent alkalinity.

The present invention is described in the German priority application No. 10 2005 016 195.2, filed Aug. 4, 2005, which is hereby incorporated by reference as is fully disclosed herein.

The invention relates to a stabilized flame retardant and to its use in flame-retardant polymer molding compositions and in flame-retardant polymer moldings.

WO 00/02869 describes polyphosphate salts of 1,3,5-triazine compounds, characterized in that their average degree of condensation n is higher than 20 and melamine content is higher than 1.1 mol of melamine per mole of phosphorus. These melamine polyphosphates are moreover intended to have a pH greater than or equal to 5 in the form of slurry whose concentration is 10% by weight in water. The use of the melamine polyphosphates in glassfiber-reinforced nylon-6,6 molding compositions and moldings is also described.

WO 96/09344 describes the use of reaction products of melamine and phosphoric acid or of melem and phosphoric acid as flame retardants in glassfiber-reinforced polyamide molding compositions. Zinc borate, zinc phosphate, etc. are used concomitantly as flame retardants.

A disadvantage of flame retardants based on the polyphosphate salts of 1,3,5-triazine compounds and, respectively, reaction products of melamine and phosphoric acid or of melem and phosphoric acid, these also being referred to below as melamine polyphosphates (MPPs), is that they have shortcomings in their compatibility with one another. This is particularly pronounced in the case of polyamides.

The lack of compatibility is seen in a reduction of the viscosity of the polymer melt comprising the flame retardant, at relatively high temperature.

Conditions of this type are encountered by way of example during injection molding. The reduction in viscosity causes polymer melt to escape from the injection nozzle of the injection molding machine. It is possible to determine both the time at which this effect begins to occur (escape time) and the amount of escaping melt (escape quantity).

Alongside these disadvantages in terms of process technology, the mechanical (strength) properties of the resultant polymer moldings (modulus of elasticity, tensile strength, tensile strain at break, impact resistance, notched impact resistance) are lastingly impaired by the lack of compatibility.

Degradation of the polymer can also be assessed via the Melt Volume Rate (MVR, or Melt Volume Index). A comparison is made here between the viscosity of a polymer melt with the additive in question and the viscosity of an untreated melt. The smaller the fall-off in viscosity in comparison with an untreated melt, the better.

An object underlying the invention is therefore to provide a flame retardant which has improved compatibility with polymers.

Surprisingly, it has been found that flame retardants based on melamine polyphosphate and comprising an additive with specific latent alkalinity in particular bring about very little degradation of the surrounding plastic (particularly via reduction in the molecular weight of the polymer) when they are incorporated into plastics. This means that the compatibility of the flame retardant has been improved and therefore that the flame retardant has been stabilized. The additive with latent alkalinity exerts a stabilizing effect. Better compatibility and a stabilizing effect result in higher escape times and lower escape quantities than in the prior art.

The invention therefore provides a stabilized flame retardant, comprising

a) from 99 to 1% by weight of melamine polyphosphate

b) from 1 to 99% by weight of additive with latent alkalinity.

The stabilized flame retardant preferably comprises

a) from 98 to 75% by weight of melamine polyphosphate

b) from 2 to 25% by weight of additive with latent alkalinity.

The stabilized flame retardant particularly preferably comprises

a) from 98 to 75% by weight of melamine polyphosphate

b) from 2 to 25% by weight of additive with latent alkalinity from the group of the zinc compounds, such as zinc oxide, zinc hydroxide, zinc oxide hydrate, zinc carbonate, zinc hydrogenphosphate, zinc stannate, zinc hydroxystannate and/or basic zinc silicate.

The stabilized flame retardant preferably also comprises a phosphinic acid and/or a phosphinic salt.

The invention therefore also provides a stabilized flame retardant, comprising

a) from 98 to 1% by weight of melamine polyphosphate

b) from 1 to 98% by weight of additive with latent alkalinity

c) from 1 to 98% by weight of phosphinic acid/salt.

The stabilized flame retardant preferably comprises

a) from 74 to 25% by weight of melamine polyphosphate

b) from 1 to 10% by weight of additive with latent alkalinity

c) from 25 to 75% by weight of phosphinic acid/salt selected from the group of aluminum trisdiethylphosphinate, aluminum trismethylethylphosphinate, titanyl bisdiethylphosphinate, titanium tetrakisdiethylphosphinate, titanyl bismethylethylphosphinate, titanium tetrakismethylethylphosphinate, zinc bisdiethylphosphinate, zinc bismethylethylphosphinate and mixtures thereof.

The melamine content of the melamine polyphosphates is preferably from 0.9 to 2.0 per mole of phosphorus.

The degree of condensation n of the melamine polyphosphates is preferably from 7 to 200, preferably from 15 to 150.

The pH of a slurry of the inventive stabilized flame retardant of 10% by weight in water is preferably greater than or equal to 5.

The latent alkalinity of the additive with latent alkalinity is preferably from 0.5 to 60% by weight, particularly preferably from 1 to 5% by weight.

The particle size (dgo) of the additive with latent alkalinity is preferably from 0.01 to 500 μm, particularly preferably from 1 to 50 μm.

The stabilized flame retardant also preferably comprises at least one binder.

The stabilized flame retardant is preferably a granulated material.

The invention therefore also provides a stabilized flame retardant which is a granulated material, comprising

a) from 98.9 to 70% by weight of melamine polyphosphate

b) from 1 to 30% by weight of additive with latent alkalinity

c) from 0.1 to 10% by weight of binder.

The invention also provides a process for stabilization of flame retardants, which comprises adding

a) from 1 to 99 parts by weight of additive with latent alkalinity to

b) from 99 to 1 parts by weight of melamine polyphosphate.

The ingredients in this process are preferably mixed at from 0 to 300° C. for from 0.01 to 10 hours in a suitable mixer.

The invention also provides the use of the inventive stabilized flame retardant as claimed in at least one of claims 1 to 14 in flame-retardant polymer molding compositions and in flame-retardant polymer moldings, in flame-retardant polymer films, in flame-retardant polymer filaments, or in flame-retardant polymer fibers.

We therefore also claim flame-retardant polymer molding compositions which comprise stabilized flame retardants as claimed in at least one of claims 1 to 14.

These flame-retardant polymer molding compositions preferably comprise from 1 to 60% by weight of stabilized flame retardant as claimed in at least one of claims 1 to 14,

from 1 to 98.5% by weight of polymer or a mixture of these,

from 0.5 to 60% by weight of additives.

The invention also provides a process for production of the flame-retardant polymer molding compositions, which comprises homogenizing the stabilized flame retardant as claimed in at least one of claims 1 to 14 in a compounding assembly at relatively high temperatures in the polymer melt with granulated polymer material and with additives, and then drawing off and cooling the homogenized polymer strand and dividing it into portions.

The invention also provides the use of these flame-retardant polymer molding compositions in flame-retardant polymer moldings, in flame-retardant polymer films, in flame-retardant polymer filaments, or in flame-retardant polymer fibers.

We therefore also claim flame-retardant polymer moldings, flame-retardant polymer films, flame-retardant polymer filaments, or flame-retardant polymer fibers, which comprise stabilized flame retardants as claimed in at least one of claims 1 to 14.

These flame-retardant polymer moldings, flame-retardant polymer films, flame-retardant polymer filaments, or flame-retardant polymer fibers, preferably comprise

from 1 to 60% by weight of stabilized flame retardant as claimed in at least one of claims 1 to 14,

from 1 to 98.5% by weight of polymer or a mixture of these

from 0.5 to 60% by weight of additives.

The flame-retardant polymer moldings, flame-retardant polymer films, flame-retardant polymer filaments, or flame-retardant polymer fibers, preferably comprise the flame-retardant polymer molding compositions as claimed in claim 18 or 19.

The flame-retardant polymer moldings, flame-retardant polymer films, flame-retardant polymer filaments, or flame-retardant polymer fibers preferably comprise

from 60 to 99% by weight of flame-retardant polymer molding composition as claimed in claim 18 or 19,

from 1 to 40% by weight of polymer or a mixture of these.

Finally, the invention also provides a process for production of flame-retardant polymer moldings, of flame-retardant polymer films, of flame-retardant polymer filaments, or of flame-retardant polymer fibers, which comprises processing flame-retardant polymer molding compositions as claimed in at least one of claims 15 to 18 via injection molding and compression molding, foam injection molding, internal-gas-pressure injection molding, blow molding, cast-film processes, calendering, lamination, or coating at relatively high temperatures to give flame-retardant polymer moldings, flame-retardant polymer films, flame-retardant polymer filaments, or flame-retardant polymer fibers.

The residual moisture level of the inventive stabilized flame retardant is preferably from 0.01 to 10% by weight, particularly preferably from 0.1 to 1% by weight.

Surprisingly, it has been found that the residual moisture level within the selected preferred range is advantageous for compatibility of the stabilized flame retardant with the polymer. Residual moisture levels above the preferred ranges reduce compatibility, i.e. increase the escape quantity from the injection nozzle, reduce escape time, impair the melt volume rate of the flame-retardant polymer molding compositions, and impair the mechanical properties of the flame-retardant polymer moldings. Moisture levels that are even lower are difficult to obtain industrially.

The median particle size (d50) of the inventive stabilized flame retardant is preferably from 0.1 to 3000 μm, particularly preferably from 0.1 to 1000 μm, and in particular from 1 to 100 μm.

The median particle size (d50) of the inventive stabilized flame retardant is preferably from 0.1 to 1000 μm, particularly preferably from 10 to 100 μm.

In another embodiment, the median particle size (d50) of the inventively stabilized flame retardant which is a granulated material is from 100 to 3000 μm, preferably from 200 to 2000 μm.

Median particle sizes (d50) within the inventively preferred range improve the compatibility of the flame retardant with the polymer.

Greater median particle sizes can lead to inhomogeneous areas (hot spots) and can reduce the compatibility of the flame retardant with the polymer. Smaller median particle sizes are difficult to obtain industrially, however.

The bulk density of the inventive stabilized flame retardant is preferably from 80 to 1500 g/l, particularly preferably from 200 to 1000 g/l.

The inventively stabilized flame retardant is preferably used in compounded form. Inventive forms may have undergone coating, dust-reduction, compacting, extrusion, melt granulation, droplet granulation, dispersion, other types of granulation, agglomeration, spray granulation, or else any other treatment.

Surprisingly, it has been found that the inventive stabilized flame retardant in compounded form improves compatibility with the polymer by easing the incorporation process, i.e. easing homogeneous dispersion of flame retardant, or giving smaller dispersed flame retardant aggregates in the polymer. The inventive stabilized flame retardant is preferably a granulated material. In one embodiment, the granulated material preferably has the shape of a cylinder with a circular, elliptical, or irregular base, or of a sphere, cushion, cube, parallelepiped, or prism.

The length:diameter ratio of the cylindrical granulated material is from 1:50 to 50:1, preferably from 1:5 to 5:1.

The diameter of the cylindrical granulated material is preferably from 0.5 to 15 mm, particularly preferably from 1 to 3 mm, its length preferably being from 0.5 to 15 mm, particularly preferably from 2 to 5 mm.

Particular preference is given to melamine polyphosphates such as ®Melapur 200/70 from Ciba-DSM Melapur, ®Budit 3141, 3141 CA, and 3141 CB, and melamine polyphosphate/melamine pyrophosphate of grades 13-1100, 13-1105, 13-1115, MPP02-244 from Hummel-Croton, and PMP-200 from Nissan.

In another embodiment, preferred melamine polyphosphates are condensates of melamine or are reaction products of melamine with phosphoric acid and, respectively, reaction products of condensates of melamine with phosphoric acid, or else a mixture of the products mentioned. Examples of condensates of melamine are melem, melam or melon and, respectively, compounds of this type having a higher level of condensation, and mixtures of these.

Reaction products with phosphoric acid are compounds produced via reaction of melamine or of the condensed melamine compounds such as melam, melem, or melon, etc., with phosphoric acid. Examples of these are melamine polyphosphate, melam polyphosphate, and melem polyphosphate and mixed polysalts.

In another embodiment, preferred melamine polyphosphates are products obtained via thermal post-treatment of reaction products of melamine and/or of condensates of melamine with phosphoric acid.

The melamine content of the melamine polyphosphates is preferably greater than 0.9 mol per mole of phosphorus.

The melamine content of the melamine polyphosphates is preferably greater than 1.1 mol per mole of phosphorus.

The melamine content of the melamine polyphosphates is preferably greater than 1.2 mol per mole of phosphorus.

The melamine content of the melamine polyphosphates is preferably from 0.9 to 2.0 mol per mole of phosphorus.

The melamine content is preferably chemically, i.e. ionically, bonded melamine and/or its condensates. No free melamine is detectable.

Inventive melamine polyphosphates are preferably composed of variable proportions of the following ingredients: melamine phosphate, dimelamine phosphate, pentamelamine triphosphate, trimelamine diphosphate, tetrakismelamine triphosphate, hexakismelamine pentaphosphate, melamine diphosphate, melamine tetraphosphate, melamine pyrophosphate, melamine polyphosphate, melam polyphosphate, melem polyphosphate, and/or melon polyphosphate.

The content of orthophosphate in the melamine polyphosphates is preferably from 0.01 to 20 mol% of phosphorus, particularly preferably from 1 to 10 mol %.

Surprisingly, it has been found that an orthophosphate content within the inventively preferred ranges leads to good compatibility of the stabilized flame retardant with the respective polymer. Higher orthophosphate contents lead to increased escape quantity and to reduced escape times. Orthophosphate contents smaller than those stated above are desirable but are difficult to obtain industrially.

Preferred forms of orthophosphate are melamine phosphate, dimelamine phosphate, pentamelamine triphosphate, trimelamine diphosphate, tetrakismelamine triphosphate, hexakismelamine pentaphosphate, melamine diphosphate, and melamine tetraphosphate.

The content of pyrophosphate in the inventive melamine polyphosphates is preferably from 0.01 to 20 mol % of phosphorus, particularly preferably from 0.1 to 10 mol %.

Surprisingly, it has been found that a pyrophosphate content within the inventively preferred ranges leads to good compatibility of the stabilized flame retardant with the respective polymer. Higher pyrophosphate contents lead to increased escape quantity and to reduced escape times. Pyrophosphate contents smaller than those stated above are desirable but are difficult to obtain industrially.

Preferred forms of pyrophosphate are provided by melamine pyrophosphate.

The content of polyphosphate in the melamine polyphosphates is preferably from 90 to 99.9 mol % of phosphorus.

Surprisingly, it has been found that a polyphosphate content within the inventively preferred ranges leads to good compatibility of the stabilized flame retardant with the respective polymer. Lower polyphosphate contents lead to increased escape quantity and to reduced escape times. Polyphosphate contents greater than those stated above are desirable but are difficult to obtain industrially.

Preferred forms of polyphosphate are melamine polyphosphate, melam polyphosphate, melem polyphosphate and/or melon polyphosphate.

The degree of condensation n of the inventive melamine polyphosphates is preferably from 7 to 200, particularly preferably from 15 to 150.

In another embodiment, the degree of condensation in the inventive melamine polyphosphates is greater than 20.

Surprisingly, it has been found that a degree of condensation within the inventively preferred ranges leads to good compatibility of the stabilized flame retardant with the respective polymer. Smaller degrees of condensation lead to increased escape quantity and to reduced escape times. Higher degrees of condensation than those stated above are desirable but are difficult to obtain industrially.

The pH of a slurry of 10% by weight of the melamine polyphosphate in water is preferably greater than 5. In another embodiment, the pH is preferably from 3 to 8, preferably from 4 to 7.

The median particle size (d50) of the melamine polyphosphates is preferably from 1 to 100 μm, particularly preferably from 6 to 20 μm.

The residual moisture level of the inventive melamine polyphosphates is preferably from 0.01 to 10% by weight, preferably from 0.1 to 1% by weight.

Characteristic data for the additive with latent alkalinity

Latent alkalinity is the ability to neutralize certain amounts of acidic content (components).

This involves a notional percentage NaOH content in the substance under consideration, equivalent to consumption of 0.1N hydrochloric acid when the substance under consideration is titrated in 0.02% strength aqueous suspension to pH 8.0 after 10 min of prior stirring at room temperature.

The latent alkalinity of the additive with latent alkalinity is preferably from 0.5 to 60% by weight, preferably from 1 to 5% by weight.

Surprisingly, it has been found that additives with latent alkalinity within the inventively preferred range improve the compatibility of the stabilized flame retardant with the respective polymer. Additives with latent alkalinity below the inventively preferred range do not lead to any stabilizing effect.

The residual moisture level of the additive with latent alkalinity is from 0.01 to 10% by weight, preferably from 0.1 to 1% by weight.

The particle size (d90) of the additive with latent alkalinity is preferably from 0.01 to 500 μm, particularly preferably from 1 to 50 μm. A particle size d90 of 50 μm means that 90% of the powder studied would pass through a sieve with mesh width 50 μm.

Surprisingly, it has been found that the particle size of the additive with latent alkalinity within the inventively preferred range leads to an improved stabilizing effect. Particle sizes that are higher or lower do not lead to the desired stabilizing effect.

The L color value of the additive with latent alkalinity is preferably from 85 to 99.9, particularly preferably from 90 to 98.

The a color value of the additive with latent alkalinity is preferably from −4 to +9, particularly preferably from −2 to +6.

The b color value of the additive with latent alkalinity is preferably from −2 to +6, particularly preferably from −1 to +3.

The color values are stated in the Hunter system (CIE-LAB-System, Commission Internationale d'Eclairage). L values range from 0 (black) to 100 (white), a values from −a (green) to +a (red), and b values from −b (blue) to +b (yellow).

Preferred additives with latent alkalinity are oxides, hydroxides, carbonates, silicates, borates, stannates, mixed oxide hydroxides, oxide hydroxide carbonates, hydroxide silicates, or hydroxide borates, or a mixture of these substances.

Other preferred additives with latent alkalinity are oxides, hydroxides, carbonates, silicates, borates, stannates, mixed oxide hydroxides, oxide hydroxide carbonates, hydroxide silicates, or hydroxide borates of the elements of the second main group, of the second transition group, and/or of the third transition group, or a mixture of these substances.

Magnesium compounds, e.g. magnesium oxide, magnesium hydroxide, magnesium hydroxide carbonate, hydrotalcites, dihydrotalcite, magnesium carbonates, or magnesium calcium carbonates, are preferred additives with latent alkalinity.

Monobasic, dibasic, or tribasic magnesium phosphate, magnesium hydrogenphosphate, magnesium pyrophosphate, or magnesium borate (Storflam MGB 11 from Storey) are preferred additives with latent alkalinity.

Calcium compounds, e.g. calcium hydroxide, calcium oxide, hydrocalumite, are preferred additives with latent alkalinity.

Monobasic, dibasic, or tribasic calcium phosphate, calcium hydrogenphosphate, and calcium pyrophosphate are preferred additives with latent alkalinity.

Barium compounds, e.g. barium hydroxide, barium oxide, barium carbonate, dibasic barium phosphate, are preferred additives with latent alkalinity.

Zinc compounds, e.g. zinc oxide (e.g. zinc oxide aktiv from Rhein Chemie, Brüggemann KG, zincite, or calamine; standard zinc oxide, G6 zinc white, 2011 zinc oxide, F-80 zinc oxide, Pharma 8 zinc white, Pharma A zinc white, Rotsiegel zinc white, and Weissiegel zinc white from Grillo-Werke AG), zinc hydroxide, zinc oxide hydrate are preferred additives with latent alkalinity.

Zinc salts of the oxo acids of the fourth main group (anhydrous zinc carbonate, basic zinc carbonate, zinc hydroxide carbonate, basic zinc carbonate hydrate, (basic) zinc silicate, zinc hexafluorosilicate, zinc hexafluorosilicate hexahydrate,.zinc stannate, zinc magnesium aluminum hydroxide carbonate) are preferred additives with latent alkalinity.

Zinc salts of the oxo acids of the third main group (zinc borate, e.g. Firebrake ZB, Firebrake 415 from Borax) are preferred additives with latent alkalinity.

Zinc salts of the oxo acids of the fifth main group (zinc phosphate, zinc hydrogenphosphate, zinc pyrophosphate) are preferred additives with latent alkalinity.

Zinc salts of the oxo acids of the transition metals (zinc chromate(VI) hydroxide (zinc yellow), zinc chromite, zinc molybdate, e.g. Kemgard 911 B, zinc permanganate, zinc molybdate-magnesium silicate, e.g. Kemgard 911 C from Sherwin-Williams Company, zinc permanganate) are preferred additives with latent alkalinity.

Zinc salts including those having organic anions, e.g. zinc salts of mono-, di-, oligo-, or polycarboxylic acids (salts of formic acid (zinc formates), of acetic acid (zinc acetates, zinc acetate dihydrate, Galzin), of trifluoroacetic acid (zinc trifluoroacetate hydrate), zinc propionate, zinc butyrate, zinc valerate, zinc caprylate, zinc oleate, zinc stearate (Liga 101 from Greven Fett-Chemie), of oxalic acid (zinc oxalate), of tartaric acid (zinc tartrate), citric acid (tribasic zinc citrate dihydrate), benzoic acid (benzoate), zinc salicylate, lactic acid (zinc lactate, zinc lactate trihydrate), acrylic acid, maleic acid, succinic acid, of amino acids (glycine), of acidic hydroxy functions (zinc phenolate, etc.), zinc para-phenolsulfonate, zinc para-phenolsulfonate hydrate, zinc acetylacetonate hydrate, zinc tannate, zinc dimethyldithiocarbamate, zinc trifluoromethanesulfonate are also preferred additives with latent alkalinity.

Zinc phosphides, zinc sulfides, zinc selenides, and zinc tellurides are preferred additives with latent alkalinity.

Zinc compounds such as zinc oxide (e.g. Zinkoxid aktiv), zinc hydroxide, zinc oxide hydrate, zinc carbonate (e.g. basic zinc carbonate, anhydrous zinc carbonate), zinc stannate, zinc hydroxystannate, basic zinc silicate, basic zinc molybdates (Kemgard 911B, Kemgard 911C from Sherwin-Williams Company), or basic zinc sulfides, are preferred additives with latent alkalinity.

Aluminum compounds, such as aluminum oxide, aluminum hydroxide, boehmite, gibbsite, or aluminum phosphate, are preferred additives with latent alkalinity.

Manganese compounds, such as manganese oxide, manganese hydroxide, are preferred additives with latent alkalinity.

Tin compounds, e.g. tin oxide, are preferred additives with latent alkalinity.

Other preferred additives with latent alkalinity are oxides, hydroxides, carbonates, silicates, borates, stannates, mixed oxide hydroxides, oxide hydroxide carbonates, hydroxide silicates, or hydroxide borates of the elements of the eighth transition group, or a mixture of these substances, e.g. alpha-FeOOH (limonite, goethite).

Similarly preferred additives with latent alkalinity are oxides, hydroxides, carbonates, silicates, borates, stannates, mixed oxide hydroxides, oxide hydroxide carbonates, hydroxide silicates, or hydroxide borates of the elements of the first transition group, or a mixture of these substances, e.g. Cu(I) oxide, Cu(II) oxide.

Boron compounds, e.g. boron phosphate (Budit 1304, Budenheim), are preferred additives with latent alkalinity.

Boron phosphate, calcium pyrophosphate, calcium borate, magnesium pyrophosphate, magnesium borate, zinc oxide, zinc hydroxide, zinc borate, zinc stearate, and/or zinc pyrophosphate are preferred additives with latent alkalinity.

The inventive stabilized flame retardant is preferably used in compounded form. Inventive forms may have been subjected to coating, dust-reduction, compacting, extrusion, melt granulation, droplet granulation, dispersion, other forms of granulation, agglomeration, spray granulation, or any other form of treatment.

In the compounding process it is preferable to use a granulation aid.

Water is preferred granulation aid. The ratio of water to the entirety of the other ingredients of the stabilized flame retardant is from 1:50 to 50:1, preferably from 1:10 to 10:1.

The compounded stabilized flame retardant preferably comprises binder.

Among preferred binders for this purpose are homopolymers of styrenesulfonic acid (PSSs) and/or their alkali metal salts with molecular weights of from 50 000 to 2 000 000.

Copolymers of styrenesulfonic acid and maleic acid in a molar ratio of from 1:2 to 2:1, and/or alkali metal salts thereof with molecular weights of from 5000 to 100 000 are preferred binders.

Polymeric polycarboxylates, such as the sodium salts of polyacrylic acid or of polymethacrylic acid, in particular those with a molecular weight of from 800 to 150 000 (based on acid) are preferred binders.

Copolymeric polycarboxylates, in particular those of acrylic acid with methacrylic acid and of acrylic acid or methacrylic acid with maleic acid, are preferred binders. Copolymers of acrylic acid with maleic acid which contain from 50 to 90% by weight of acrylic acid and from 50 to 10% by weight of maleic acid have proven particularly suitable. Their molecular weight, based on free acids, is generally from 5000 to 200 000, preferably from 10 000 to 120 000, and in particular from 50 000 to 100 000.

Polymers having more than two different monomer units are preferred binders, e.g. those which contain, as monomers, salts of acrylic acid and of maleic acid, and also contain vinyl alcohol or vinyl alcohol derivatives, or which contain, as monomers, salts of acrylic acid and of 2-alkylallylsulfonic acid, and also contain sugar derivatives.

Other preferred binders are copolymers which preferably contain, as monomers, acrolein and acrylic acid/acrylic salts and, respectively, vinyl acetate.

Oxidation products of polyglucosanes containing carboxy groups are preferred binders, as are, in combination therewith or instead thereof, their water-soluble salts.

Polyaspartic acids and their salts and derivatives are preferred binders.

Polyacetals prepared via reaction of dialdehydes with polyolcarboxylic acids which have from 5 to 7 carbon atoms and at least 3 hydroxy groups are preferred binders. Preferred polyacetals are obtained from dialdehydes such as glyoxal, glutaraldehyde, terephthalaldehyde or else from mixtures of these, and from polyolcarboxylic acids such as gluconic acid and/or glucoheptonic acid.

Polyvinylpyrrolidones (PVPs) are preferred binders and are commercially available with various molecular weights (MW) in the form of ®Luviskol (BASF, Germany; ®Luviskol K90 (MW 32 1 200 000 to 2 000 000), ®Luviskol K30 (MW=45 000 to 55 000), ®Luviskol K17 (MW=7000 to 11 000)). Polyvinylpyrrolidone with molecular weight of from 45 000 to 2 000 000 is particularly preferred.

Other preferred binders are polyvinyl alcohol (®Mowiol 8-88, ®Mowiol 40-88, ®Mowiol 3-85 from Kuraray). Particular preference is given to partially hydrolyzed polyvinyl alcohols whose degree of hydrolysis is from 85 to 95 mol %, whose ester value is from 80 to 220 mg KOH/g, and whose viscosity is from 2.5 to 49 mPa*s at 20° C. in 4% by weight aqueous dispersion. Particular preference is also given to fully hydrolyzed polyvinyl alcohols whose degree of hydrolysis is from 97 to 100 mol %, whose ester value is from 3 to 40 mg KOH/g, and whose viscosity is from 2.8 to 60 mPa*s at 20° C in 4% by weight aqueous dispersion.

Polyvinyl butyral (PVB), polyvinylcaprolactam, and hydroxyethylcellulose and hydroxypropylcellulose, and also sodium carboxymethylcellulose, are preferred binders.

Vinylacetate Polymers

Binders based on at least one of the following monomers or a mixture of these are preferred: vinyl acetate, 2-ethylhexyl acrylate, acrolein, acrylic ester, acrylic acid, crotonic acid, dibutyl maleate, ethylene, methyl methacrylate, n-butyl acrylate,

N-hydroxymethylacrylamide, N-vinylpyrrolidone, styrene, tert-butyl chloride, vinyl chloride, vinyl laurate, vinyl propionate. Preferred representatives are ™Airflex EP3360, EP16, EAF375 from Air Products, and ™Mowilith LDM from Kuraray.

Acrylates

Binders-based on at least one of the following monomers or a mixture thereof are preferred: methacrylate, 1,2-butadiene, 1,3-butadiene, 2-ethylhexyl acrylate, acrylamide, acrylonitrile, acrylic acid, ethyl acrylate, ethyl methacrylate, isobutyl acrylate, isobutyl methacrylate, lauryl acrylate, and/or methyl methacrylate, methacrylamide, methacrylonitrile, methacrylic acid, n-butyl acrylate, n-butyl methacrylate, n-hexyl acrylate, n-hexyl methacrylate, n-propyl acrylate, sec-butyl acrylate, styrene, tert-butyl acrylate, tert-butyl methacrylate, vinyl acetate, vinyl chloride, vinylidene chloride, vinyl propionate. Preferred representative is Acronal 18D from BASF.

Other Preferred Binders are Film-Forming Binders.

Homopolymers based on vinyl acetate are preferred binders, as also are copolymers based on vinyl acetate, ethylene, and vinyl chloride, copolymers based on vinyl acetate and on a vinyl ester of a long-chain, branched carboxylic acid, copolymers based on vinyl acetate and di-n-butyl maleate, copolymers based on vinyl acetate and acrylic ester, copolymers based on styrene and acrylic ester, copolymers based on acrylate/vinyltoluene, copolymers based on acrylate/styrene, copolymers based on acrylate/vinyl, and/or self-crosslinking polyurethane dispersions.

Other Additives

Preferred additives which can be used for the inventive stabilized flame retardants are dialkylphosphinic salts of the formula (I) 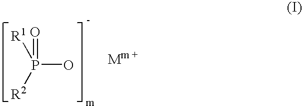
in which

R¹ and R² are identical or different and are C₁-C₆-alkyl, linear or branched;

M is Mg, Ca, Al, Sb, Sn, Ge, Ti, Fe, Zr, Zn, Ce, Bi, Sr, Mn, Li, Na, K, and/or
a protonated nitrogen base;

m is from 1 to 4.

M is preferably aluminum, calcium, titanium, zinc, tin, or zirconium.

R¹ and R², identical or different, are preferably C₁-C₆-alkyl, linear or branched.

R¹ and R², identical or different, are particularly preferably methyl, ethyl, n-propyl, isopropyl, n-butyl, isobutyl, tert-butyl, n-pentyl, isopentyl, n-hexyl, and/or isohexyl.

Preferred dialkylphosphinic salts are aluminum trisdiethylphosphinate, aluminum trismethylethylphosphinate, titanyl bisdiethylphosphinate, titanium tetrakisdiethylphosphinate, titanyl bismethylethylphosphinate, titanium tetrakismethylethylphosphinate, zinc bisdiethylphosphinate, zinc bismethylethylphosphinate and mixtures thereof.

The telomer content of the inventive dialkylphosphinic salts is preferably from 0.1 to 5% by weight.

The telomers are. preferably those from the group of C₂-alkyl-C₄-alkylphosphinic salts, C₄-alkyl-C₄-alkylphosphinic salts, C₂-alkyl-C₆-alkylphosphinic salts, C₄-alkyl-C₆-alkyl-phosphinic salts, and C₆-alkyl-C₆-alkylphosphinic salts.

The telomers are preferably ethylbutylphosphinic salts, butylbutylphosphinic salts, ethylhexylphosphinic salts, butylhexylphosphinic salts, or hexylhexylphosphinic salts.

The median particle size (d50) of the dialkylphosphinic salts is from 0.1 to 3000 μm, preferably from 0.1 to 1000 μm, and in particular from 1 to 100 μm.

Preferred additives for the inventive stabilized flame retardants are antioxidants, such as aromatic amines, sterically hindered phenols (butylated hydroxytoluene (BHT), thiobisphenol, relatively high-molecular-weight polyphenols, tetrakis(methylene[2,5-di-tert-butyl-4-hydroxyhydrocinnamate])methane (®Irganox 1010), octadecyl 3,5-di-tert-butyl-4-hydroxyhydrocinnamate (®Irganox 1076), organophosphites (tris(nonylphenyl) phosphite (TNPP)), thioesters (distearyl 3,3′-thiodipropionate, ditridecyl 3,3′-thiodipropionate, dilauryl 3,3′-thiodipropionate), metal deactivators (®Irganox 1024), vitamin E (alpha-tocopherol), lactone, or hydroxylamine.

Antistatic agents such as fatty acid esters (glycerol, polyethylene glycol esters, sorbitol esters), quaternary ammonium compounds, ethoxylated amines, and also alkylsulfonates, are additives which can preferably be used for the inventive stabilized flame retardants.

Blowing agents, such as azodicarbonamide, p,p-oxybis(benzenesulfonyl hydrazide) (OBSH), 5-phenyltetrazole (5PT), p-toluenesulfonylsemicarbazide (TSSC), and also trihydrazinetriazine (THT) are additives which can preferably be used for the inventive stabilized flame retardants.

Flame retardants such as alumina trihydrate, antimony oxide, brominated aromatic or cycloaliphatic hydrocarbons, phenols, ethers, chloroparaffin, hexachlorocyclopentadiene adducts (®Dechloran Plus, Occidental Chemical Co), red phosphorus, melamine derivatives, melamine cyanurates, ammonium polyphosphates, and magnesium hydroxide, are additives that can preferably be used for the inventive stabilized flame retardants.

Heat stabilizers are additives that can preferably be used for the inventive stabilized flame retardants, examples being lead stabilizers, dibasic lead phthalate, dibasic lead stearate, lead silicate, monobasic and tribasic lead sulfate, dibasic lead carbonate, dibasic lead phosphite, mixed metal salts (the barium cadmium, barium zinc, and calcium zinc salts of 2-ethylhexylcarboxylic acid, stearic acid, ricinoleic acid, and/or lauric acid, and other examples being substituted phenols, organotin stabilizers (mono- and dialkyltin mercaptides (thioglycolates), dialkyltin carboxylates (maleates, laurates, tin-esters), and secondary heat stabilizers (alkyl/arylorganophosphites, epoxy compounds of unsaturated fatty acids and fatty acid esters).

ImPact modifiers/processing aids are additives that can preferably be used for the inventive stabilized flame retardants, examples being acrylates, acrylonitrile-butadiene-styrene (ABS), chlorinated polyethylene (CPE), ethylene-propylene terpolymer (EPT), ethylene-vinyl acetate (EVA), and methacrylate-butadiene-styrene (MBS).

Lubricants are additives that can preferably be used for the inventive stabilized flame retardants, examples being fatty acid amides (fatty acid monoamides, fatty acid bisamides, oleamides, erucamides, ethylenebisstearamide (EBSA), ethylenebisoleamide (EBSA)), fatty acids/fatty acid esters (C16-C18 (palmitic acid, stearic acid, oleic acid)), fatty alcohols (cetyl alcohol, stearyl alcohol), waxes (paraffin waxes, polyethylene waxes), metal stearates (calcium stearate, zinc stearate, magnesium stearate, barium stearate, aluminum stearate, cadmium stearate, lead stearate).

Light stabilizers are additives that can preferably be used for the inventive stabilized flame retardants, examples being UV absorbers (alkyl-substituted hydroxybenzophenones, e.g. 2-hydroxy-4-alkoxybenzophenones, alkyl-substituted hydroxybenzothiazoles, e.g. 2-hydroxy-3,5-dialkylbenzotriazoles), UV quenchers (nickel diethyldithiocarbamate, zinc diethyldithiocarbamate, n-butylaminenickel-2,2′-thiobis(4-tert-octylphenolate), nickel bis(monoethyl 3,5-di-tert-butyl-4-hydroxybenzyl)phosphonate), free-radical inhibitors (bis(2,2′,6,6′-tetramethyl-4-piperidyl) sebacate (HALS)), hydroperoxide decomposers (dithiophosphates).

Other additives that can be used concomitantly are antidrip agents, compatibilizers, fillers, reinforcing materials, nucleating agents, additives for laser marking, hydrolysis stabilizers, chain extenders, color pigments, and plasticizers.

The invention also provides a process for production of stabilized flame retardants which comprise melamine polyphosphate and comprise at least one additive with latent alkalinity.

Mixing

In one embodiment, the inventive stabilized flame retardant can be prepared by mixing the ingredients in a suitable mixer at from 0 to 300° C. for from 0.01 to 10 hours without increasing grain size.

Inventive mixers can be: plowshare mixers from Lödige, annular gap mixers from Lödige, (e.g. CB30), Flexomix mixers from Schugi, annular gap mixers HEC from Niro, annular gap mixer (e.g. K-TTE4) from Drais, Mannheim, Eirich mixers (e.g. R02), Telschig mixers (WPA6), Hauf mixers (the last two mixers using the free-fall principle of operation), zig-zag mixers from Niro, and mixers from Nauta in which the mix is circulated via a screw by the Archimedes principle. Tumbling mixers and Hobart mixers are also suitable.

The process for preparation of stabilized flame retardants which comprise melamine polyphosphate and comprise at least one additive with latent alkalinity can also be part of a compounding process. A compounded, stabilized flame retardant has a specifically adjusted grain size which by way of example is greater than that of the additives and melamine polyphosphates used.

In one embodiment, the inventive stabilized granulated flame retardant material can be prepared by adding the granulation aid and/or the binder in a suitable mixer or in a dish granulator to the moving mixture composed of melamine polyphosphate and of the additive with latent alkalinity, and mixing the materials for from 0.01 to 10 hours at from 0 to 300° C.

The crude product initially produced can be dried in a suitable dryer, or heat-conditioned to give a further increase in grain size. Inventive dryers can be: fluidized-bed dryers from Hosokawa Schugi (Schugi Fluid-Bed, Vometec fluidized-bed dryer), fluidized-bed dryers from Waldner or from Glatt, turbo-fluidized-bed dryers from Waldner, spin-flash dryers from Anhydro, or else drum dryers.

Preferred operating conditions in the fluidized-bed dryer are: air input temperature

from 120 to 280° C., product temperature from 20 to 200° C.

In one embodiment, the inventive stabilized flame retardant can be prepared via roller compaction. In this process, the solid particles are interlocked via exposure to external pressure between two rollers. The solid that forms is mechanically comminuted via breaking to give grains which are classified into oversize, correct-size, and undersize grains. The correct-size grains are the desired product, while oversize and undersize grains are recycled.

The compaction pressure preferably used is from 1 kN/cm² to 60 kN/cm².

Preferred roller compacting apparatus are compactors from Hosokawa-Bepex GmbH (Pharmapaktor®), Alexanderwerk (WP 120×40 V, WP 170×120 V, WP 200×75 VN, WP 300×100 V), and roll presses from Köppern.

Grain size is optimized via grinding and subsequent classification. Examples of suitable equipment for the grinding process are hammer mills, impact mills, vibration grinding mills, ball mills, roll mills, and floating-roll mills from Neuman & Esser, and also air-jet mills, such as machines from Hosokawa-Alpine. Classification processes used are sifting and/or sieving. For the sieving process, use may be made of Allgeier, Rhewum, or Locker sieves, for example.

In one embodiment, the inventive stabilized flame retardant can be prepared by mixing the ingredients, i.e. at least the melamine polyphosphate and at least one additive with latent alkalinity, and extruding and chopping the material (or, if appropriate breaking and classifying the material), and drying the material (and, if appropriate, coating it).

The preferred extrusion temperatures are from 10 to 500° C.

For this process, preference is given to granulating presses from Kahl (e.g. ®24-390/500 presses), pelletizing presses from Schlüter (®PP 85, PP 127, PP 200, PP 360), benchtop granulators from Fitzpatrick, low-pressure dome or basket extruders from Fitzpatrick, twin-screw extruders from Leistritz (®ZSE 27/40/50/60/75/100/135,ZSE27HP/40/50/60/75/87), laboratory extruders from Leistritz (®MICRO 18/27), single-screw extruders from Leistritz (®ESE 30/40/50/60/70 /80/90/120/150/200), water-cooled die-face pelletizers, etc., and/or circulatory compactors (edge runners).

In one embodiment, the inventive stabilized flame retardant can be prepared via spray granulation. In spray-bed granulation, the material to be agglomerated is fluidized via a stirrer or via a stream of gas to give a fluidized bed. Further material to be agglomerated, dispersed in a solvent, is applied by spraying to this fluidized bed. The wet particles coalesce onto the existing agglomerates. A hot stream of gas evaporates the solvent and thus dries the agglomerates. A portion of the fluidized bed is continuously discharged, the correct-size grains are isolated, and coarse particles are comminuted and, together with excessively fine particles, returned to the fluidized bed.

Use of the Stabilized Flame Retardant

It is preferable to use the inventive stabilized flame retardants composed of melamine polyphosphate and of at least one additive with latent alkalinity in flame-retardant polymer molding compositions and in flame-retardant polymer moldings.

Process for Stabilization of Flame Retardants

A preferred process for stabilization of flame retardants comprises adding

a) from 1 to 99 parts by weight of addive with latent alkalinity to

b) from 99 to 1 parts by weight of inventive melamine polyphosphate.

A preferred process for stabilization of flame retardants comprises adding

a) from 0.3 to 30 parts by weight of additive with latent alkalinity to

b) from 99.7 to 70 parts by weight of inventive melamine polyphosphate.

A particularly preferred process for stabilization of flame retardants comprises adding

a) from 3 to 30 parts by weight of additive with latent alkalinity to

b) from 97 to 70 parts by weight of inventive melamine polyphosphate.

Another preferred process for stabilization of flame retardants comprises adding

a) from 1 to 98 parts by weight of additive with latent alkalinity to

b) from 98 to 1 parts by weight of inventive melamine polyphosphate and

c) from 1 to 98 parts by weight of phosphinic acid.

Another particularly preferred process for stabilization of flame retardants comprises adding

a) from 1 to 10 parts by weight of additive with latent alkalinity to

b) from 89 to 10 parts by weight of inventive melamine polyphosphate

c) from 10 to 80 parts by weight of phosphinic acid.

Another preferred process for stabilization of flame retardants comprises adding

a) from 3 to 30 parts by weight of additive with latent alkalinity to

b) from 97 to 70 parts by weight of inventive melamine polyphosphate

c) from 0.1 to 10 parts by weight of binder.

Surprisingly, it has been found that the inventive process for stabilization of flame retardants can achieve higher escape times and lower escape quantities than the prior art.

Flame-Retardant Polymer Molding Compositions

The invention also provides flame-retardant polymer compositions comprising the inventive stabilized flame retardant.

The flame-retardant polymer molding composition preferably comprises

from 1 to 60% by weight of inventive stabilized flame retardant,

from 1 to 98.5% by weight of polymer or a mixture of these,

from 0.5 to 60% by weight of additives.

The flame-retardant polymer molding composition also preferably comprises

from 1 to 60% by weight of inventive stabilized flame retardant,

from 1 to 98% by weight of polymer or a mixture of these,

from 0.5 to 60% by weight of additives and

from 0.5 to 60% by weight of filler and/or reinforcing material.

The flame-retardant polymer molding composition particularly preferably comprises

from 5 to 30% by weight of inventive stabilized flame retardant,

from 5 to 90% by weight of polymer or a mixture of these,

from 5 to 40% by weight of additives and

from 5 to 40% by weight of filler and/or reinforcing material.

The polymers preferably derive from the group of the thermoplastic polymers, such as polyester, polystyrene, or polyamide, and/or from the thermoset polymers.

The flame-retardant polymer molding composition is preferably a granulated material (extrudate, compounded material). The granulated material preferably has the shape of a cylinder with a circular, elliptical, or irregular base, or that of a sphere, cushion, cube, parallelepiped, or prism.

The length:diameter ratio of the granulated material is from 1:50 to 50:1, preferably from 1:5 to 5:1.

The diameter of the granulated material is preferably from 0.5 to 15 mm, particularly preferably from 2 to 3 mm, its length preferably being from 0.5 to 15 mm, particularly preferably from 2 to 5 mm.

The residual moisture level of the flame-retardant polymer molding composition is preferably from 0.01 to 10% by weight, preferably from 0.1 to 1% by weight.

Preferred melt volume rates of the flame-retardant polymer molding compositions based on polyamide are from 0 to 15, particularly from 3 to 12.

Surprisingly, it has been found that the residual moisture level within the preferred range is advantageous for compatibility of the stabilized flame retardant with the polymer. Residual moisture levels above the preferred ranges reduce compatibility, i.e. increase the escape quantity, reduce the escape time, impair the melt volume rate of the flame-retardant polymer molding composition, and impair the mechanical properties of the flame-retardant polymer moldings. Lower residual moisture levels than the abovementioned are difficult to obtain industrially.

The preferred amount of escaped flame-retardant polymer molding composition during preparation of the flame-retardant polymer molding composition is

from 0 to 8 g/2 min.

The preferred time prior to escape of the flame-retardant polymer molding composition during preparation of the flame-retardant polymer molding composition is from 6 to 5000 sec, preferably from 10 to 1000 sec.

The invention also provides a process for preparation of flame-retardant polymer molding compositions, which comprises homogenizing the inventive stabilized flame retardants in a compounding assembly at relatively high temperatures with the granulated polymer material and optionally with additives in the polymer melt, and then drawing off and cooling the homogenized polymer strand and dividing it into portions.

The resultant granulated material is by way of example dried for 10 h at 90° C. in an oven with air circulation.

The compounding assembly preferably derives from the group of the single-screw extruders, multizone screws, or twin-screw extruders.

Suitable compounding assemblies are single-screw extruders, for example from Berstorff GmbH, Hanover, and/or from Leistritz, Nuremberg, =multizone screw extruders with three-zone screws and/or short-compression-section screws, co-kneaders, e.g. from Coperion Buss Compounding Systems, Pratteln, Switzerland, e.g. MDK/E46-11D, and/or laboratory kneaders (MDK 46 from Buss, Switzerland, with L=11D); twin-screw extruders, from Coperion Werner & Pfleiderer GmbH & Co. KG, Stuttgart (ZSK 25, ZSK30, ZSK 40, ZSK 58, ZSK MEGAcompounder 40, 50, 58, 70, 92, 119, 177, 250, 320, 350, 380), and/or from Berstorff GmbH, Hanover, Leistritz Extrusionstechnik GmbH, Nuremberg; ring extruders, e.g. from 3+Extruder GmbH, Laufen with a ring of from three to twelve small screws which rotate around a static core, and/or planetary-gear extruders, for example from Entex, Bochum, and/or vented extruders and/or cascade extruders, and/or Maillefer screws; compounders with counter-rotating twin-screw system, e.g. Compex 37 or Compex 70 from Krauss-Maffei Berstorff.

Preferred effective screw lengths (L) of the extruder (compounding assembly) expressed as a multiple of screw diameter (D) are from 4 to 200D, preferably from 10 to 50D.

Effective screw lengths (L) for single-screw extruders are from 20 to 40D; for multizone-screw extruders they are by way of example 25D with feed zone (L=10D), transition zone (L=6D), metering zone (L=9D); and for twin-screw extruders they are from 8 to 48D.

The processing temperatures are preferably from 170 to 200° C. for polystyrene, from 200 to 300° C. for polypropylene, from 250 to 290° C. for polyethylene terephthalate (PET), from 230 to 270° C. for polybutylene terephthalate (PBT), from 260 to 290° C. for nylon-6 (PA 6), from 260 to 290° C. for nylon-6,6 (PA 6.6), and from 280 to 320° C. for polycarbonate.

Preference is given to use of the inventive flame-retardant polymer molding compositions in flame-retardant polymer moldings.

The inventive flame-retardant polymer moldings are suitable for production of fibers, of foils, or of moldings, in particular for applications in the electrical and electronics sector.

The invention also provides flame-retardant polymer moldings, flame-retardant polymer films, flame-retardant polymer filaments, and flame-retardant polymer fibers, comprising the inventive stabilized flame retardants and/or the inventive flame-retardant polymer molding compositions.

The flame-retardant polymer moldings, flame-retardant polymer films, flame-retardant polymer filaments, and flame-retardant polymer fibers preferably comprise

from 1 to 60% by weight of inventive stabilized flame retardants,

from 1 to 99% by weight of polymer or a mixture of these

from 0.5 to 60% by weight of additives and

from 0.5 to 60% by weight of filler and/or reinforcing material.

The flame-retardant polymer moldings, flame-retardant polymer films, flame-retardant polymer filaments, and flame-retardant polymer fibers particularly preferably comprise

from 5 to 40% by weight of inventive stabilized flame retardants,

from 5 to 90% by weight of polymer or a mixture of these

from 5 to 40% by weight of additives and

from 5 to 40% by weight of fillers and/or reinforcing material.

The invention also provides flame-retardant polymer moldings, flame-retardant polymer films, flame-retardant polymer filaments, and flame-retardant polymer fibers, comprising the inventive flame-retardant polymer molding compositions.

These flame-retardant polymer moldings, flame-retardant polymer films, flame-retardant polymer filaments, and flame-retardant polymer fibers preferably comprise from 60 to 98% by weight of flame-retardant polymer molding composition, and

from 1 to 40% by weight of polymer or a mixture of these.

These flame-retardant polymer moldings, flame-retardant polymer films, flame-retardant polymer filaments, and flame-retardant polymer fibers particularly preferably comprise from 60 to 98% by weight of flame-retardant polymer molding composition,

from 1 to 40% by weight of polymer or a mixture of these

from 0.2 to 40% by weight of additives

from 0.2 to 40% by weight of filler or of reinforcing materials.

Surprisingly, it has been found that the inventive flame-retardant polymer moldings, inventive flame-retardant polymer films, inventive flame-retardant polymer filaments, and inventive flame-retardant polymer fibers have improved mechanical (strength) properties (modulus of elasticity, tensile strength, tensile strain at break, impact resistance, notched impact resistance) by virtue of the inventive stabilized flame retardants, the flame retardants stabilized by the inventive process, and/or inventive flame-retardant polymer molding compositions.

The UL-94 classification of the polymer moldings is V-1 or V-0 for the abovementioned flame-retardant polymer moldings, flame-retardant polymer films, flame-retardant polymer filaments, and flame-retardant polymer fibers.

Finally, the invention also provides a process for production of flame-retardant polymer moldings, which comprises processing inventive flame-retardant polymer molding compositions via injection molding and compression molding, foam injection molding, internal-gas-pressure injection molding, blow molding, cast-film processes, calendering, lamination, or coating at relatively high temperatures to give the flame-retardant polymer molding.

Examples of preferred injection-molding machines are Aarburg Allrounder machines.

The processing temperatures in these processes are preferably from 200 to 250° C. for polystyrene, from 200 to 300° C. for polypropylene, from 250 to 290° C. for polyethylene terephthalate (PET), from 230 to 270° C. for polybutylene terephthalate (PBT), from 260 to 290° C. for nylon-6 (PA 6), from 260 to 290° C. for nylon-6,6 (PA 6.6), and from 280 to 320° C. for polycarbonate.

Surprisingly, it has been found that the inventive process for production of flame-retardant polymer moldings has improvements by virtue of lower escape quantities and higher escape times, by virtue of the inventive stabilized flame retardants, the flame retardants stabilized by the inventive process, and/or inventive flame-retardant polymer molding compositions.

According to the invention, preference is given to use of inventive flame-retardant polymer moldings as lamp parts, such as lamp sockets and lamp holders, plugs and multipoint connectors, coil formers, casings for capacitors or connectors, and circuit-breakers, relay housings, and reflectors.

Other embodiments can readily be produced as a function of the nature of the test specimen to be machined.

Polymers that can be used according to the invention are thermoset and thermoplastic polymers.

The polymers are preferably polymers of monoolefins and of diolefins, examples being polypropylene, polyisobutylene, poly-1-butene, poly-4-methyl-1-pentene, polyisoprene, or polybutadiene, or else polymers of cycloolefins, e.g. of cyclopentene or norbornene; and polyethylene (which may, if appropriate, have been crosslinked), e.g. high-density polyethylene (HDPE), high-density high-molecular-weight polyethylene (HMWHDPE), high-density ultrahigh-molecular-weight polyethylene (UHMWHDPE), medium-density polyethylene (MDPE), low-density polyethylene (LDPE), linear low-density polyethylene (LLDPE), branched low-density polyethylene (BLDPE), or else a mixture thereof.

The polymers are preferably copolymers of monoolefins or of diolefins with one another or with other vinyl monomers, e.g. ethylene-propylene copolymers, linear low-density polyethylene (LLDPE), or a mixture of this with low-density polyethylene (LDPE), or are propylene-1-butene copolymers, propylene-isobutylene copolymers, ethylene-i-butene copolymers, ethylene-hexene copolymers, ethylene-methylpentene copolymers, ethylene-heptene copolymers, ethylene-octene copolymers, propylene-butadiene copolymers, isobutylene-isoprene copolymers, ethylene-alkyl acrylate copolymers, ethylene-alkyl methacrylate copolymers, ethylene-vinyl acetate copolymers and their copolymers with carbon monoxide, or are ethylene-acrylic acid copolymers and their salts (ionomers), or else are terpolymers of ethylene with propylene and with a diene, such as hexadiene, dicyclopentadiene, or ethylidenenorbornene; and mixtures of these copolymers with one another, e.g. polypropylene/ethylene-propylene copolymers, LDPE/ethylene-vinyl acetate copolymers, LDPE/ethylene-acrylic acid copolymers, LLDPE/ethylene-vinyl acetate copolymers, LLDPE/ethylene-acrylic acid copolymers, and alternating or random polyalkylene/carbon monoxide copolymers and their mixtures with other polymers, e.g. with polyamides.

The polymers are preferably hydrocarbon resins (e.g. C₅-C₉), and these include hydrogenated modifications thereof (e.g. tackifier resins), and mixtures of polyalkylenes and starch.

The polymers are preferably polystyrene (polystyrene 143E (BASF), poly(p-methylstyrene), poly(alpha-methylstyrene).

The polymers are preferably copolymers of styrene or alpha-methylstyrene with dienes or with acrylic derivatives, e.g. styrene-butadiene, styrene-acrylonitrile, styrene alkyl methacrylate, styrene-butadiene-alkyl acrylate and styrene-butadiene-alkyl methacrylate, styrene-maleic anhydride, styrene-acrylonitrile-methyl acrylate; mixtures of high impact resistance composed of styrene copolymers and of another polymer, e.g. of a polyacrylate, of a diene polymer, or of an ethylene-propylene-diene terpolymer; and block copolymers of styrene, e.g. styrene-butadiene-styrene, styrene-isoprene-styrene, styrene-ethylene/butylene-styrene, or styrene-ethylene/propylene-styrene.

The polymers are preferably graft copolymers of styrene or alpha-methylstyrene, e.g styrene on polybutadiene, styrene on polybutadiene-styrene copolymers or on polybutadiene-acrylonitrile copolymers, styrene and acrylonitrile (or methacrylonitrile) on polybutadiene; styrene, acrylonitrile, and methyl methacrylate on polybutadiene; styrene and maleic anhydride on polybutadiene; styrene, acrylonitrile, and maleic anhydride or maleimide on polybutadiene; styrene and maleimide on polybutadiene, styrene and alkyl acrylates and, respectively, alkyl methacrylates on polybutadiene, styrene and acrylonitrile on ethylene-propylene-diene terpolymers, styrene and acrylonitrile on polyalkyl acrylates or on polyalkyl methacrylates, styrene and acrylonitrile on acrylate-butadiene copolymers, and also mixtures of these, for example those known as ABS polymers, MBS polymers, ASA polymers, or AES polymers.

The polymers are preferably halogen-containing polymers, e.g. polychloroprene, chlorinated rubber, chlorinated and brominated copolymer composed of isobutylene-isoprene (halobutyl rubber), chlorinated or chlorosulfonated polyethylene, copolymers of ethylene and of chlorinated ethylene, epichlorohydrin homo- and copolymers, in particular polymers composed of halogen-containing vinyl compounds, e.g. polyvinyl chloride, polyvinylidene chloride, polyvinyl fluoride, polyvinylidene fluoride; and also copolymers of these, e.g. vinyl chloride-vinylidene chloride, vinyl chloride-vinyl acetate, or vinylidene chloride-vinyl acetate.

The polymers are preferably polymers which derive from alpha-, beta-unsaturated acids and from their derivatives, e.g. polyacrylates and polymethacrylates, butyl-acrylate-impact-modified polymethyl methacrylates, polyacrylamides, and polyacrylonitriles, and copolymers of the monomers mentioned with one another or with other unsaturated monomeres, e.g. acrylonitrile-butadiene copolymers, acrylonitrile-alkyl acrylate copolymers, acrylonitrile-alkoxyalkyl acrylate copolymers, acrylonitrile-vinyl halide copolymers, or acrylonitrile-alkyl methacrylate-butadiene terpolymers.

The polymers are preferably polymers which derive from unsaturated alcohols and amines and, respectively, from their acyl derivatives or acetals, e.g. polyvinyl alcohol, polyvinyl acetate, polyvinyl stearate, polyvinyl benzoate, polyvinyl maleate, polyvinyl butyral, polyallyl phthalate, polyallylmelamine; and their copolymers with olefins.

The polymers are preferably homo- and copolymers of cyclic ethers, for example are polyalkylene glycols, polyethylene oxide, polypropylene oxide, or their copolymers with bisglycidyl ethers.

The polymers are preferably polyacetals, such as polyoxymethylene, or else polyoxymethylenes which contain comonomers, e.g. ethylene oxide; polyacetals which have been modified with thermoplastic polyurethanes, with acrylates, or with MBS.

The polymers are preferably polyphenylene oxides and polyphenylene sulfides or a mixture of these with styrene polymers or with polyamides.

The polymers are preferably polyurethanes derived firstly from polyethers, from polyesters, and from polybutadienes where these have terminal hydroxy groups, and derived secondly from aliphatic or aromatic polyisocyanates, or else are precursors of these.

The polymers are preferably polyamides and copolyamides derived from diamines and from dicarboxylic acids, and/or from aminocarboxylic acids or from the corresponding lactams, examples being nylon-2,12, nylon-4(poly-4-aminobutyric acid, ®Nylon 4, DuPont), nylon-4,6(poly(tetramethyleneadipamide), poly(tetramethyleneadipic diamide), ®Nylon 4/6, DuPont), nylon-6(polycaprolactam, poly-6-aminohexanoic acid, ®Nylon 6, DuPont, ®Akulon K122, DSM; ®Zytel 7301, DuPont; ®Durethan B 29, Bayer), nylon-6,6((poly(N,N′-hexamethyleneadipic diamide), ®Nylon 6/6, DuPont, ®Zytel 101, DuPont; ®Durethan A30, ®Durethan AKV, ®Durethan AM, Bayer; ®Ultramid A3, BASF), nylon-6,9(poly(hexamethylenenonane diamide), ®Nylon 6/9, DuPont), nylon-6,10(poly(hexamethylenesebacamide), ®Nylon 6/10, DuPont), nylon-6,12(poly(hexamethylenedodecane diamide), ®Nylon 6/12, DuPont), nylon-6/6,6(poly(hexamethyleneadipamide-co-caprolactam), ®Nylon 6/66, DuPont), nylon-7(poly-7-aminoheptanoic acid, ®Nylon 7, DuPont), nylon-7,7(polyheptamethylenepimelamide, ®Nylon 7,7, DuPont), nylon-8(poly-8-aminooctanoic acid, ®Nylon 8, DuPont), nylon-8,8(polyoctamethylenesuberamide, ®Nylon 8,8, DuPont), nylon-9(poly-9-aminononanoic acid, Nylon 9, DuPont), nylon-9,9(polynonamethyleneazelamide, ™Nylon 9,9, DuPont), nylon-10(poly-10-amino-decanoic acid, ®Nylon 10, DuPont), nylon-10,9(poly(decamethyleneazelamide), ®Nylon 10,9, DuPont), nylon-10,10(polydecamethylenesebacamide, ®Nylon 10,10, DuPont), nylon-11(poly-11-aminoundecanoic acid, ®Nylon 11, DuPont), nylon-12(polylaurolactam, ®Nylon 12 , DuPont, ®Grillamid L20, Ems Chemie), aromatic polyamides derived from m-xylene, diamine, and adipic acid; polyamides prepared from hexamethylenediamine and iso- and/or terephthalic acid (polyhexamethyleneisophthalamide polyhexamethyleneterephthalamide) and, if appropriate, from an elastomer as modifier, e.g. poly-2,4,4-trimethylhexamethyleneterephthalamide or poly-m-phenyleneisophthalamide. Block copolymers of the abovementioned polyamides with polyolefins, with olefin copolymers, with ionomers, or with chemically bonded or grafted elastomers; or with polyethers, e.g. with polyethylene glycol, polypropylene glycol, or polytetramethylene glycol. Also EPDM- or ABS-modified polyamides or copolyamides; and also polyamides condensed during processing (“RIM polyamide systems”).

The polymers are preferably polyureas, polyimides, polyamideimides, polyetherimides, polyesterimides, polyhydantoins, or polybenzimidazoles.

The polymers are preferably polyesters which derive from dicarboxylic acids and from dialcohols, and/or from hydroxycarboxylic acids, or from the corresponding lactones, e.g. polyethylene terephthalate, polybutylene terephthalate (®Celanex 2500, ®Celanex 2002, Celanese; ®Ultradur, BASF), poly-1,4-dimethylolcyclohexane terephthalate, polyhydroxybenzoates, and also block polyetheresters which derive from polyethers having hydroxy end groups; also polyesters modified with polycarbonates or with MBS.

The polymers are preferably polycarbonates and polyester carbonates.

The polymers are preferably polysulfones, polyether sulfones, and polyether ketones.

The polymers are preferably crosslinked polymers which derive firstly from aldehydes and secondly from phenols, from urea, or from melamine, examples being phenol-formaldehyde resins, urea-formaldehyde resins, and melamine-formaldehyde resins.

The polymers are preferably drying and non-drying alkyd resins. aminoundecanoic The polymers are preferably unsaturated polyester resins which derive from copolyesters of saturated and unsaturated dicarboxylic acids with polyhydric alcohols, and also from vinyl compounds as crosslinking agents, or else are halogen-containing, flame-retardant modifications thereof.

The polymers are preferably crosslinkable acrylic resins which derive from substituted acrylic esters, e.g. from epoxy acrylates, from urethane acrylates, or from polyester acrylates.

The polymers are preferably alkyd resins, polyester resins, and acrylate resins which have been crosslinked with melamine resins, with urea resins, with isocyanates, with isocyanurates, with polyisocyanates, or with epoxy resins.

The polymers are preferably crosslinked epoxy resins which derive from aliphatic, cycloaliphatic, heterocyclic, or aromatic glycidyl compounds, e.g. products of bisphenol A diglycidyl ethers, of bisphenol-F diglycidyl ethers, which are crosslinked by means of conventional hardeners, e.g. by means of anhydrides or of amines, with or without accelerators.

The polymers are preferably mixtures (polyblends) of the abovementioned polymers, e.g. PP/EPDM, polyamide/EPDM, or ABS, PVC/EVA, PVC/ABS, PVC/MBS, PC/ABS, PBTP/ABS, PC/ASA, PC/PBT, PVC/CPE, PVC/acrylates, POM/thermoplastic PU, PC/thermoplastic PU, POM/acrylate, POM/MBS, PPO/HIPS, PPO/PA 6.6 and copolymers, PA/HDPE, PA/PP, PA/PPO, PBT/PC/ABS, or PBT/PET/PC.

Determiniation of amount of escaped flame-retardant polymer molding composition (escape quantity):

Flame-retardant polymer molding composition discharged after 2 min from the injection nozzle of an Aarburg Allrounder injection-molding machine is taken and weighed.

Time elapsed prior to escape of flame-retardant polymer molding composition (escape time):

The time elapsed prior to escape of flame-retardant polymer molding composition was measured on an Aarburg Allrounder injection-molding machine.

Determination of Latent Alkalinity

A 0.02% strength suspension of the substance to be studied in water is stirred for 10 min at room temperature and then titrated to pH 8.0 with 0.1N hydrochloric acid. The molar consumption of hydrochloric acid is then converted to the equivalent number of moles of NaOH (which is the base used for calculation purposes) and then to the appropriate weight of 100% NaOH. The weight of NaOH is expressed as a percentage based on the initial weight of substance to be studied. The quotient obtained is the latent alkalinity.

Preparation, processing, and testing of flame-retardant polymer molding compositions and polymer moldings.

The flame retardant components [not defined] were mixed with the polymer pellets and with any additives, and incorporated at temperatures of from 230 to 260° C. (GRPBT) or from 260 to 280° C. (GRPA 66) on a twin-screw extruder (Leistritz LSM 30/34). The homogenized polymer strand was drawn off, cooled in a water bath, and then pelletized.

After sufficient drying, the molding compositions were processed to give test specimens in an injection-molding machine (Aarburg Allrounder) at melt temperatures of from 240 to 270° C. (GRPBT) or from 260 to 290° C. (GRPA 66). The UL 94 (Underwriters Laboratories) fire classification was determined on test specimens composed of each mixture, using test specimens of thickness 1.5 mm.

The UL 94 fire classifications are as follows:

V-0: Afterflame time never longer than 10 sec, total of afterflame times for 10 flame applications not more than 50 sec, no flaming drops, no complete consumption of the specimen, afterglow time for specimens never longer than 30 sec after end of flame application

V-1: Afterflame time never longer than 30 sec after end of flame application, total of afterflame times for 10 flame applications not more than 250 sec, afterglow time for specimens never longer than 60 sec after end of flame application, other criteria as for V-0

V-2: Cotton indicator ignited by flaming drops; other criteria as for V-1

Not classifiable (ncl): does not comply with fire classification V-2.

The invention is further illustrated by the examples below.

### EXAMPLES 1 to 11

### Determination of Latent Alkalinity

### EXAMPLE 1

The latent alkalinity of magnesium oxide is determined in accordance with the “Determination of latent alkalinity” specification. The result is listed in Table 1.

### EXAMPLE 2

The latent alkalinity of magnesium hydroxide is determined in accordance with the “Determination of latent alkalinity” specification. The result is listed in Table 1.

### EXAMPLE 3

The latent alkalinity of magnesium hydroxide carbonate is determined in accordance with the “Determination of latent alkalinity” specification. The result is listed in Table 1.

### EXAMPLE 4

The latent alkalinity of barium oxide is determined in accordance with the “Determination of latent alkalinity” specification. The result is listed in Table 1.

### EXAMPLE 5

The latent alkalinity of zinc oxide is determined in accordance with the “Determination of latent alkalinity” specification. The result is listed in Table 1.

### EXAMPLE 6

The latent alkalinity of zinc hydroxide carbonate is determined in accordance with the “Determination of latent alkalinity” specification. The result is listed in Table 1.

### EXAMPLE 7

The latent alkalinity of zinc hydroxystannate is determined in accordance with the “Determination of latent alkalinity” specification. The result is listed in Table 1.

### EXAMPLE 8 (comparison)

The latent alkalinity of zinc borate is determined in accordance with the “Determination of latent alkalinity” specification. No significant latent alkalinity is measured. The result is listed in Table 1.

### EXAMPLE 9 (comparison)

The latent alkalinity of zinc phosphate is determined in accordance with the “Determination of latent alkalinity” specification. No significant latent alkalinity is measured. The result is listed in Table 1.

### EXAMPLE 10

The latent alkalinity of aluminum hydroxide is determined in accordance with the “Determination of latent alkalinity” specification. The result is listed in Table 1.

### EXAMPLE 11

The latent alkalinity of chalk is determined in accordance with the “Determination of latent alkalinity” specification. The result is listed in Table 1.

### Examples 12-28

### Preparation of Flame Retardants

### EXAMPLE 12 (comparison)

5 kg of a flame retardant composed of 95% by weight of melamine polyphosphate 1 and 5% by weight of zinc borate is prepared in a Lödige mixer.

### EXAMPLE 13 (comparison)

5 kg of a flame retardant composed of 95% by weight of melamine polyphosphate 1 and 5% by weight of zinc phosphate is prepared in a Lödige mixer.

### EXAMPLE 14

5 kg of a flame retardant composed of 98% by weight of melamine polyphosphate 1 and 2% by weight of zinc oxide 1 is prepared in a Lödige mixer.

### EXAMPLE 15

5 kg of a flame retardant composed of 95% by weight of melamine polyphosphate 1 and 5% by weight of zinc oxide 2 is prepared in a Lödige mixer.

### EXAMPLE 16 (comparison)

5 kg of a flame retardant composed of 95% by weight of melamine polyphosphate 1 and 5% by weight of zinc oxide 3 is prepared in a Lödige mixer.

### EXAMPLE 17 (comparison)

5 kg of a flame retardant composed of 95% by weight of melamine polyphosphate 1 and 5% by weight of zinc oxide 4 is prepared in a Lödige mixer.

### EXAMPLE 18

5 kg of a flame retardant composed of 80% by weight of melamine polyphosphate 1 and 20% by weight of zinc oxide 1 is prepared in a Lödige mixer.

### EXAMPLE 19

5 kg of a flame retardant composed of 95% by weight of melamine polyphosphate 1 and 5% by weight of zinc hydroxide carbonate is prepared in a Lödige mixer.

### EXAMPLE 20

5 kg of a flame retardant composed of 95% by weight of melamine polyphosphate 1 and 5% by weight of zinc hydroxystannate is prepared in a Lödige mixer.

### EXAMPLE 21

5 kg of a flame retardant composed of 95% by weight of melamine polyphosphate 1 and 5% by weight of magnesium hydroxide is prepared in a Lödige mixer.

### EXAMPLE 22

5 kg of a flame retardant composed of 95% by weight of melamine polyphosphate 1 and 5% by weight of aluminum hydroxide is prepared in a Lödige mixer.

### EXAMPLE 23

5 kg of a flame retardant composed of 95% by weight of melamine polyphosphate 1 and 5% by weight of chalk is prepared in a Lödige mixer.

### EXAMPLE 24 (comparison)

5 kg of a flame retardant composed of 33% by weight of melamine polyphosphate 1 and 67% by weight of aluminum diethylphosphinate is prepared in a Lödige mixer.

### EXAMPLE 25

5 kg of a flame retardant composed of 33% by weight of melamine polyphosphate 1, 2% by weight of zinc oxide, and 65% by weight of aluminum diethylphosphinate is prepared in a Lödige mixer.

### EXAMPLE 26

5 kg of a flame retardant composed of 32% by weight of melamine polyphosphate 1, 5% by weight of zinc oxide, and 63% by weight of aluminum diethylphosphinate is prepared in a Lödige mixer.

### EXAMPLE 27

5 kg of a flame retardant composed of 30% by weight of melamine polyphosphate 1,10% by weight of zinc oxide, and 60% by weight of aluminum diethylphosphinate is prepared in a Lödige mixer.

### EXAMPLE 28

5 kg of a flame retardant composed of 92% by weight of melamine polyphosphate 1, 5% by weight of zinc oxide, and 3% by weight of binder is prepared in a Lödige mixer.

### EXAMPLE 29 (comparison)

In accordance with the general “Preparation, processing, and testing of flame-retardant polymer molding compositions and of flame-retardant polymer moldings” specification, 45 parts by weight of nylon-6, 25 parts by weight of melamine polyphosphate 1, and 30 parts by weight of glass fibers 1 are processed to give a molding composition. The molding composition is further processed to give flame-retardant polymer moldings (UL 94 test specimens). Escape quantity and escape time are determined for this flame-retardant polymer molding composition. The results are listed in Table 3. The test specimens tested to Underwriters Laboratories UL 94 comply with category V-0.

### EXAMPLE s 30 to 52

### Preparation, Processing, and Testing of Flame-Retardant Polymer Molding Compositions and of Flame-Retardant Polymer Moldings

### EXAMPLE 30 (comparison)

In accordance with the general “Preparation, processing, and testing of flame-retardant polymer molding compositions and of flame-retardant polymer moldings” specification, 45 parts by weight of nylon-6, 25 parts by weight of flame retardant of Example 12, and 30 parts by weight of glass fibers 1 are processed to give a molding composition. The molding composition is further processed to give flame-retardant polymer moldings (UL 94 test specimens). Escape quantity and escape time are determined for this flame-retardant polymer molding composition. The results are listed in Table 3. The test specimens tested to Underwriters Laboratories UL 94 comply with category V-0.

### EXAMPLE 31 (comparison)

In accordance with the general “Preparation, processing, and testing of flame-retardant polymer molding compositions and of flame-retardant polymer moldings” specification, 45 parts by weight of nylon-6, 25 parts by weight of flame retardant of Example 13, and 30 parts by weight of glass fibers 1 are processed to give a molding composition. The molding composition is further processed to give flame-retardant polymer moldings (UL 94 test specimens). Escape quantity and escape time are determined for this flame-retardant polymer molding composition. The results are listed in Table 3. The test specimens tested to Underwriters Laboratories UL 94 comply with category V-0.

### EXAMPLE 32

In accordance with the general “Preparation, processing, and testing of flame-retardant polymer molding compositions and of flame-retardant polymer moldings” specification, 55 parts by weight of nylon-6, 15 parts by weight of stabilized flame retardant of Example 14, and 30 parts by weight of glass fibers 1 are processed to give a molding composition. The molding composition is further processed to give flame-retardant polymer moldings (UL 94 test specimens). Escape quantity and escape time are determined for this flame-retardant polymer molding composition. The results are listed in Table 3. Because inventive stabilized flame retardant is used, they are significantly better than in Comparative Examples 29, 30, and 31. The test specimens tested to Underwriters Laboratories UL 94 comply with category V-1.

### EXAMPLE 33

In accordance with the general “Preparation, processing, and testing of flame-retardant polymer molding compositions and of flame-retardant polymer moldings” specification, 45 parts by weight of nylon-6, 25 parts by weight of stabilized flame retardant of Example 15, and 30 parts by weight of glass fibers 1 are processed to give a molding composition. The molding composition is further processed to give flame-retardant polymer moldings (UL 94 test specimens). Escape quantity and escape time are determined for this flame-retardant polymer molding composition. The results are listed in Table 3. Because inventive stabilized flame retardant is used, they are significantly better than in Comparative Examples 29, 30, and 31. The test specimens tested to Underwriters Laboratories UL 94 comply with category V-0.

### EXAMPLE 34 (comparison)

In accordance with the general “Preparation, processing, and testing of flame-retardant polymer molding compositions and of flame-retardant polymer moldings” specification, 45 parts by weight of nylon-6, 25 parts by weight of stabilized flame retardant of Example 16, and 30 parts by weight of glass fibers 1 are processed to give a molding composition. The molding composition is further processed to give flame-retardant polymer moldings (UL 94 test specimens). Escape quantity and escape time are determined for this flame-retardant polymer molding composition. The results are listed in Table 3. They are poorer than in inventive Example 33. The test specimens tested to Underwriters Laboratories UL 94 comply with category V-0.

### EXAMPLE 35 (comparison)

In accordance with the general “Preparation, processing, and testing of flame-retardant polymer molding compositions and of flame-retardant polymer moldings” specification, 45 parts by weight of nylon-6, 25 parts by weight of stabilized flame retardant of Example 17, and 30 parts by weight of glass fibers 1 are processed to give a molding composition. The molding composition is further processed to give flame-retardant polymer moldings (UL 94 test specimens). Escape quantity and escape time are determined for this flame-retardant polymer molding composition. The results are listed in Table 3. They are poorer than in inventive Example 33. The test specimens tested to Underwriters Laboratories UL 94 comply with category V-0.

### EXAMPLE 36

In accordance with the general “Preparation, processing, and testing of flame-retardant polymer molding compositions and of flame-retardant polymer moldings” specification, 35 parts by weight of nylon-6, 35 parts by weight of stabilized flame retardant of Example 18, and 30 parts by weight of glass fibers 1 are processed to give a molding composition. The molding composition is further processed to give flame-retardant polymer moldings (UL 94 test specimens). Escape quantity and escape time are determined for this flame-retardant polymer molding composition. The results are listed in Table 3. Because inventive stabilized flame retardant is used, they are significantly better than in Comparative Examples 29, 30, and 31. The test specimens tested to Underwriters Laboratories UL 94 comply with category V-0.

### EXAMPLE 37

In accordance with the general “Preparation, processing, and testing of flame-retardant polymer molding compositions and of flame-retardant polymer moldings” specification, 45 parts by weight of nylon-6, 25 parts by weight of stabilized flame retardant of Example 19, and 30 parts by weight of glass fibers 1 are processed to give a molding composition. The molding composition is further processed to give flame-retardant polymer moldings (UL 94 test specimens). Escape quantity and escape time are determined for this flame-retardant polymer molding composition. The results are listed in Table 3. Because inventive stabilized flame retardant is used, they are significantly better than in Comparative Examples 29, 30, and 31. The test specimens tested to Underwriters Laboratories UL 94 comply with category V-0.

### EXAMPLE 38

In accordance with the general “Preparation, processing, and testing of flame-retardant polymer molding compositions and of flame-retardant polymer moldings” specification, 45 parts by weight of nylon-6, 25 parts by weight of stabilized flame retardant of Example 20, and 30 parts by weight of glass fibers 1 are processed to give a molding composition. The molding composition is further processed to give flame-retardant polymer moldings (UL 94 test specimens). Escape quantity and escape time are determined for this flame-retardant polymer molding composition. The results are listed in Table 3. Because inventive stabilized flame retardant is used, they are significantly better than in Comparative Examples 29, 30, and 31. The test specimens tested to Underwriters Laboratories UL 94 comply with category V-0.

### EXAMPLE 39

In accordance with the general “Preparation, processing, and testing of flame-retardant polymer molding compositions and of flame-retardant polymer moldings” specification, 45 parts by weight of nylon-6, 25 parts by weight of stabilized flame retardant of Example 21, and 30 parts by weight of glass fibers 1 are processed to give a molding composition. The molding composition is further processed to give flame-retardant polymer moldings (UL 94 test specimens). Escape quantity and escape time are determined for this flame-retardant polymer molding composition. The results are listed in Table 3. Because inventive stabilized flame retardant is used, they are significantly better than in Comparative Examples 29, 30, and 31. The test specimens tested to Underwriters Laboratories UL 94 comply with category V-0.

### EXAMPLE 40

In accordance with the general “Preparation, processing, and testing of flame-retardant polymer molding compositions and of flame-retardant polymer moldings” specification, 45 parts by weight of nylon-6, 25 parts by weight of flame retardant of Example 22, and 30 parts by weight of glass fibers 1 are processed to give a molding composition. The molding composition is further processed to give flame-retardant polymer moldings (UL 94 test specimens). Escape quantity and escape time are determined for this flame-retardant polymer molding composition. The results are listed in Table 3. Because inventive stabilized flame retardant is used, they are significantly better than in Comparative Examples 29, 30, and 31. The test specimens tested to Underwriters Laboratories UL 94 comply with category V-0.

### EXAMPLE 41

In accordance with the general “Preparation, processing, and testing of flame-retardant polymer molding compositions and of flame-retardant polymer moldings” specification, 45 parts by weight of nylon-6, 25 parts by weight of stabilized flame retardant of Example 23, and 30 parts by weight of glass fibers 1 are processed to give a molding composition. The molding composition is further processed to give flame-retardant polymer moldings (UL 94 test specimens). Escape quantity and escape time are determined for this flame-retardant polymer molding composition. The results are listed in Table 3. Because inventive stabilized flame retardant is used, they are significantly better than in Comparative Examples 29, 30, and 31. The test specimens tested to Underwriters Laboratories UL 94 comply with category V-0.

### EXAMPLE 42 (comparison)

In accordance with the general “Preparation, processing, and testing of flame-retardant polymer molding compositions and of flame-retardant polymer moldings” specification, 50 parts by weight of nylon-6, 20 parts by weight of stabilized flame retardant of Example 24, and 30 parts by weight of glass fibers 1 are processed to give a molding composition. The molding composition is further processed to give flame-retardant polymer moldings (UL 94 test specimens). Escape quantity and escape time are determined for this flame-retardant polymer molding composition. The results are listed in Table 3. The test specimens tested to Underwriters Laboratories UL 94 comply with category V-0.

### EXAMPLE 43

In accordance with the general “Preparation, processing, and testing of flame-retardant polymer molding compositions and of flame-retardant polymer moldings” specification, 55 parts by weight of nylon-6, 15 parts by weight of flame retardant of Example 25, and 30 parts by weight of glass fibers 1 are processed to give a molding composition. The molding composition is further processed to give flame-retardant polymer moldings (UL 94 test specimens). Escape quantity and escape time are determined for this flame-retardant polymer molding composition. The results are listed in Table 3. Because inventive stabilized flame retardant is used, they are significantly better than in Comparative Example 42. The test specimens tested to Underwriters Laboratories UL 94 comply with category V-1.

### EXAMPLE 44

In accordance with the general “Preparation, processing, and testing of flame-retardant polymer molding compositions and of flame-retardant polymer moldings” specification, 50 parts by weight of nylon-6, 20 parts by weight of flame retardant of Example 26, and 30 parts by weight of glass fibers 1 are processed to give a molding composition. The molding composition is further processed to give flame-retardant polymer moldings (UL 94 test specimens). Escape quantity and escape time are determined for this flame-retardant polymer molding composition. The results are listed in Table 3. Because inventive stabilized flame retardant is used, they are significantly better than in Comparative Example 42. The test specimens tested to Underwriters Laboratories UL 94 comply with category V-0.

### EXAMPLE 45

In accordance with the general “Preparation, processing, and testing of flame-retardant polymer molding compositions and of flame-retardant polymer moldings” specification, 40 parts by weight of nylon-6, 30 parts by weight of stabilized flame retardant of Example 27, and 30 parts by weight of glass fibers 1 are processed to give a molding composition. The molding composition is further processed to give flame-retardant polymer moldings (UL 94 test specimens). Escape quantity and escape time are determined for this flame-retardant polymer molding composition. The results are listed in Table 3. Because inventive stabilized flame retardant is used, they are significantly better than in Comparative Example 42. The test specimens tested to Underwriters Laboratories UL 94 comply with category V-0.

### EXAMPLE 46

In accordance with the general “Preparation, processing, and testing of flame-retardant polymer molding compositions and of flame-retardant polymer moldings” specification, 45 parts by weight of nylon-6, 25 parts by weight of stabilized flame retardant of Example 28, and 30 parts by weight of glass fibers 1 are processed to give a molding composition. The molding composition is further processed to give flame-retardant polymer moldings (UL 94 test specimens). Escape quantity and escape time are determined for this flame-retardant polymer molding composition. The results are listed in Table 3. Because inventive stabilized flame retardant is used, they are significantly better than in Comparative Example 42. The test specimens tested to Underwriters Laboratories UL 94 comply with category V-0.

### EXAMPLE 47 (comparison)

In accordance with the general “Preparation, processing, and testing of flame-retardant polymer molding compositions and of flame-retardant polymer moldings” specification, 45 parts by weight of nylon-6,6, 25 parts by weight of melamine polyphosphate 1, and 30 parts by weight of glass fibers 2 are processed to give a molding composition. The molding composition is further processed to give flame-retardant polymer moldings (UL 94 test specimens). Escape quantity and escape time are determined for this flame-retardant polymer molding composition. The results are listed in Table 3. The test specimens tested to Underwriters Laboratories UL 94 comply with category V-0.

### EXAMPLE 48 (comparison)

In accordance with the general “Preparation, processing, and testing of flame-retardant polymer molding compositions and of flame-retardant polymer moldings” specification, 45 parts by weight of nylon-6,6, 25 parts by weight of stabilized flame retardant of Example 12, and 30 parts by weight of glass fibers 2 are processed to give a molding composition. The molding composition is further processed to give flame-retardant polymer moldings (UL 94 test specimens). Escape quantity and escape time are determined for this flame-retardant polymer molding composition. The results are listed in Table 3. The test specimens tested to Underwriters Laboratories UL 94 comply with category V-0.

### EXAMPLE 49

In accordance with the general “Preparation, processing, and testing of flame-retardant polymer molding compositions and of flame-retardant polymer moldings” specification, 45 parts by weight of nylon-6,6, 25 parts by weight of stabilized flame retardant of Example 15, and 30 parts by weight of glass fibers 2 are processed to give a molding composition. The molding composition is further processed to give flame-retardant polymer moldings (UL 94 test specimens). Escape quantity and escape time are determined for this flame-retardant polymer molding composition. The results are listed in Table 3. Because inventive stabilized flame retardant is used, they are significantly better than in Comparative Examples 47 and 48. The test specimens tested to Underwriters Laboratories UL 94 comply with category V-0.

### EXAMPLE 50

In accordance with the general “Preparation, processing, and testing of flame-retardant polymer molding compositions and of flame-retardant polymer moldings” specification, 45 parts by weight of nylon-6,6, 25 parts by weight of stabilized flame retardant of Example 19, and 30 parts by weight of glass fibers 2 are processed to give a molding composition. The molding composition is further processed to give flame-retardant polymer moldings (UL 94 test specimens). Escape quantity and escape time are determined for this flame-retardant polymer molding composition. The results are listed in Table 3. Because inventive stabilized flame retardant is used, they are significantly better than in Comparative Examples 47 and 48. The test specimens tested to Underwriters Laboratories UL 94 comply with category V-0.

### EXAMPLE 51 (comparison)

In accordance with the general “Preparation, processing, and testing of flame-retardant polymer molding compositions and of flame-retardant polymer moldings” specification, 50 parts by weight of nylon-6,6, 20 parts by weight of flame retardant of Example 24, and 30 parts by weight of glass fibers 2 are processed to give a molding composition. The molding composition is further processed to give flame-retardant polymer moldings (UL 94 test specimens). Escape quantity and escape time are determined for this flame-retardant polymer molding composition. The results are listed in Table 3. The test specimens tested to Underwriters Laboratories UL 94 comply with category V-0.

### EXAMPLE 52

In accordance with the general “Preparation, processing, and testing of flame-retardant polymer molding compositions and of flame-retardant polymer moldings” specification, 50 parts by weight of nylon-6,6, 20 parts by weight of stabilized flame retardant of Example 26, and 30 parts by weight of glass fibers-2 are processed to give a molding composition. The molding composition is further processed to give flame-retardant polymer moldings (UL 94 test specimens). Escape quantity and escape time are determined for this flame-retardant polymer molding composition. The results are listed in Table 3. Because inventive stabilized flame retardant is used, they are significantly better than in Comparative Example 51. The test specimens tested to Underwriters Laboratories UL 94 comply with category V-0.

EXAMPLES 32, 33, 36-41 (produced from inventive stabilized flame-retardants of Examples 14,15,18-23) exhibit the surprising stabilizing effect of the additive with latent alkalinity on flame-retardant molding compositions composed of nylon-6 in comparison with Comparative Examples 29 (without additive), 30 (based on zinc borate; flame retardant from Comparative Example 12) and 31 (based on zinc phosphate; flame retardant from Comparative Example 13).

EXAMPLES 32 and 33 (produced from inventive stabilized flame retardants of Examples 14 and 15) exhibit the advantageous stabilizing effect of the inventive d90 particle size of the additive with latent alkalinity on the flame-retardant molding compositions composed of nylon-6. Examples 34 and 35 (produced from flame retardants of Comparative Examples 16 and 17) serve as comparison with non-inventive particle size.

EXAMPLES 43-45 (produced from inventive stabilized flame retardants of Examples 25-27) exhibit the surprising stabilizing effect of the additive with latent alkalinity on aluminum-diethylphosphinate-containing flame-retardant molding compositions composed of nylon-6 in comparison with Comparative Example 42 (produced from flame retardant of Comparative Example 24; without additive).

EXAMPLE 46 (produced from inventive stabilized granulated flame retardant material of Example 28) exhibits the surprising stabilizing effect of the additive with latent alkalinity on flame-retardant molding compositions composed of nylon-6.

EXAMPLES 49 and 50 (produced from inventive stabilized flame retardants of Examples 15 and 19) exhibit the surprising stabilizing effect of the additive with latent alkalinity on flame-retardant molding compositions composed of nylon-6.6 in comparison with Comparative Examples 47 and 48 (produced without addition and, respectively, from flame retardants of Comparative Example 12 based on zinc borate).

EXAMPLE 52 (produced from inventive stabilized flame retardant of Example 26) exhibits the surprising stabilizing effect of the additive with latent alkalinity on aluminum diethylphosphinate-containing flame-retardant molding compositions composed of nylon-6.6 in comparison with Comparative Example 51 (produced from flame retardants of Comparative Example 24 without addition).

Chemicals used

| | |
|---|---|
| Magnesium oxide | magnesium oxide MgO, Riedel de Haen |
| Magnesium | very high purity magnesium hydroxide |
| hydroxide | Mg(OH)₂, Merck, d90 = about 5 μm |
| Magnesium | magnesium hydroxide carbonate, Merck |
| hydroxide | |
| carbonate | |
| Barium oxide | barium oxide, Alfa Aesar |
| zinc oxide 1 | AA zinc oxide, Omya, d90 = about 1.4 μm |
| zinc oxide 2 | zinc oxide Alfa Aesar, d90 = about 45 μm |
| zinc oxide 3 | zinc oxide Alfa Aesar, d90 = about 0.071 μm |
| zinc oxide 4 | zinc oxide Alfa Aesar, d90 = about 76 μm |
| zinc hydroxide | zinc hydroxide carbonate, Riedel de Haen |
| carbonate | |
| zinc borate | ®Firebrake 500, Borax |
| zinc | ®Flamtard H, Blythe, d90 = about 10 μm |
| hydroxystannate | |
| zinc phosphate | zinc phosphate, Alfa Aesar |
| Aluminum | aluminum hydroxide Al(OH)₃, Martinswerk |
| hydroxide | |
| Chalk | ®Omyalyte, Omya |
| Aluminum | ®Exolit OP 1230, Clariant, residual moisture |
| diethyl- | level <0.3% |
| phosphinate | |
| Nylon-6.6 | ®Ultramid A3, BASF |
| Nylon-6 | ®Zytel 7301, DuPont |
| Glass fibers 1 | ®Vetrotex EC 10 983, Saint-Gobain |
| Glass fibers 2 | PPG 3540, PPG Industries, Inc. |
| Melamine | ®Melapur 200/70, Ciba SC; constitution: |
| polyphosphate 1 | orthophosphate 1.4 mol %, pyrophosphate 1.2 mol %, |
| | polyphosphate 97 mol %, degree of condensation |
| | n 108, residual moisture level 0.18% by weight, |
| | melamine content 1.18 mol per mole of phosphorus, |
| | pH (10% by weight aqueous slurry) 5.1, |
| | d50 <10 μm, residual moisture level <0.2% |
| Binder | ®Mowiol 3-86, Kuraray |

TABLE 1

| Example | Additive with latent alkalinity | Latent alkalinity % |
|---|---|---|
| 1 | Magnesium oxide | 163.2 |
| 2 | Magnesium hydroxide | 36.0 |
| 3 | Magnesium hydroxide carbonate | 44.5 |
| 4 | Barium oxide | 52.0 |
| 5 | Zinc oxide 1 | 1.3 |
| 6 | Zinc hydroxide carbonate | 1.7 |
| 7 | Zinc hydroxystannate | 2.5 |
| 8 (comp.) | Zinc borate | 0.0 |
| 9 (comp.) | Zinc phosphate | 0.0 |
| 10 | Aluminum hydroxide | 3.9 |
| 11 | Chalk | 2.3 |

TABLE 2
Constitution of flame retardants

| | | Example | | | | | | | | | | | | | | | | |
|---|---|---|---|---|---|---|---|---|---|---|---|---|---|---|---|---|---|---|
| | | 12 | 13 | | | 16 | 17 | | | | | | | 24 | | | | |
| | | (comp) | (comp) | 14 | 15 | (comp) | (comp) | 18 | 19 | 20 | 21 | 22 | 23 | (comp) | 25 | 26 | 27 | 28 |
| Melamine polyphosphate 1 | % by wt. | 95 | 95 | 98 | 95 | 95 | 95 | 80 | 95 | 95 | 95 | 95 | 95 | 33 | 33 | 32 | 30 | 92 |
| Zinc borate | % by wt. | 5 | | | | | | | | | | | | | | | | |
| Zinc phosphate | % by wt. | | 5 | | | | | | | | | | | | | | | |
| Zinc oxide 1 | % by wt. | | | 2 | 5 | | | 20 | | | | | | 0 | 2 | 5 | 10 | 5 |
| Zinc oxide 2 | % by wt. | | | | | 5 | | | | | | | | | | | | |
| Zinc oxide 3 | % by wt. | | | | | | 5 | | | | | | | | | | | |
| Zinc hydroxide carbonate | % by wt. | | | | | | | | 5 | | | | | | | | | |
| Zinc hydroxystannate | % by wt. | | | | | | | | | 5 | | | | | | | | |
| Magnesium hydroxide | % by wt. | | | | | | | | | | 5 | | | | | | | |
| Aluminum hydroxide | % by wt. | | | | | | | | | | | 5 | | | | | | |
| Chalk | % by wt. | | | | | | | | | | | | 5 | | | | | |
| Aluminum diethylphosphinate | % by wt. | | | | | | | | | | | | | 67 | 65 | 63 | 60 | |
| Granulation aid | % by wt. | | | | | | | | | | | | | | | | | 3 |

TABLE 3
Properties of flame-retardant polymer molding compositions and moldings

| | | Example | | | | | | | | | | | |
|---|---|---|---|---|---|---|---|---|---|---|---|---|---|
| | | 29 | 30 | 31 | | | 34 | 35 | | | | | |
| | | (comp) | (comp) | (comp) | 32 | 33 | (comp) | (comp) | 36 | 37 | 38 | 39 | 40 |
| Nylon-6 | % by wt. | 45 | 45 | 45 | 55 | 45 | 45 | 45 | 35 | 45 | 45 | 45 | 45 |
| Nylon-6,6 | % by wt. | | | | | | | | | | | | |
| Melamine polyphosphate 1 | % by wt. | 25 | | | | | | | | | | | |
| Flame retardant, Example 12 | % by wt. | | 25 | | | | | | | | | | |
| Flame retardant, Example 13 | % by wt. | | | 25 | | | | | | | | | |
| Flame retardant, Example 14 | % by wt. | | | | 15 | | | | | | | | |
| Flame retardant, Example 15 | % by wt. | | | | | 25 | | | | | | | |
| Flame retardant, Example 16 | % by wt. | | | | | | 25 | | | | | | |
| Flame retardant, Example 17 | % by wt. | | | | | | | 25 | | | | | |
| Flame retardant, Example 18 | % by wt. | | | | | | | | 35 | | | | |
| Flame retardant, Example 19 | % by wt. | | | | | | | | | 25 | | | |
| Flame retardant, Example 20 | % by wt. | | | | | | | | | | 25 | | |
| Flame retardant. Example 21 | % by wt. | | | | | | | | | | | 25 | |
| Flame retardant, Example 22 | % by wt. | | | | | | | | | | | | 25 |
| Flame retardant, Example 23 | % by wt. | | | | | | | | | | | | |
| Flame retardant, Example 24 | % by wt. | | | | | | | | | | | | |
| Flame retardant, Example 25 | % by wt. | | | | | | | | | | | | |
| Flame retardant, Example 26 | % by wt. | | | | | | | | | | | | |
| Flame retardant, Example 27 | % by wt. | | | | | | | | | | | | |
| Flame retardant, Example 28 | % by wt. | | | | | | | | | | | | |
| Glass fibers 1 | % by wt. | 30 | 30 | 30 | 30 | 30 | 30 | 30 | 30 | 30 | 30 | 30 | 30 |
| Glass fibers 2 | % by wt. | | | | | | | | | | | | |
| Amounts of escaped flame- | g, 2 min | 12.1 | 13.0 | 9.7 | 1.2 | 1.1 | 9.8 | 12.2 | 1.4 | 0.9 | 1.2 | 1.8 | 2.5 |
| retardant polymer molding | | | | | | | | | | | | | |
| composition | | | | | | | | | | | | | |
| Time elapsed prior to escape | sec | 2 | 0 | 2 | 55 | 40 | 5 | 3 | 55 | 40 | 41 | 45 | 40 |
| of flame-retardant polymer | | | | | | | | | | | | | |
| molding composition | | | | | | | | | | | | | |
| UL 94 classification of flame- | — | V-0 | V-0 | V-0 | V-1 | V-0 | V-0 | V-0 | V-0 | V-0 | V-0 | V-0 | V-0 |
| retardant polymer moldings | | | | | | | | | | | | | |

Example

| | | | 42 | | | | | 47 | 48 | | | 51 | |
|---|---|---|---|---|---|---|---|---|---|---|---|---|---|
| | | 41 | (comp) | 43 | 44 | 45 | 46 | (comp) | (comp) | 49 | 50 | (comp) | 52 |
| Nylon-6 | % by wt. | 45 | 50 | 55 | 50 | 40 | 45 | | | | | | |
| Nylon-6,6 | % by wt. | | | | | | | 45 | 45 | 45 | 45 | 50 | 50 |
| Melamine polyphosphate 1 | % by wt. | | | | | | | 25 | | | | | |
| Flame retardant, Example 12 | % by wt. | | | | | | | | 25 | | | | |
| Flame retardant, Example 13 | % by wt. | | | | | | | | | | | | |
| Flame retardant, Example 14 | % by wt. | | | | | | | | | | | | |
| Flame retardant, Example 15 | % by wt. | | | | | | | | | 25 | | | |
| Flame retardant, Example 16 | % by wt. | | | | | | | | | | | | |
| Flame retardant, Example 17 | % by wt. | | | | | | | | | | | | |
| Flame retardant, Example 18 | % by wt. | | | | | | | | | | | | |
| Flame retardant, Example 19 | % by wt. | | | | | | | | | | 25 | | |
| Flame retardant, Example 20 | % by wt. | | | | | | | | | | | | |
| Flame retardant. Example 21 | % by wt. | | | | | | | | | | | | |
| Flame retardant, Example 22 | % by wt. | | | | | | | | | | | | |
| Flame retardant, Example 23 | % by wt. | 25 | | | | | | | | | | | |
| Flame retardant, Example 24 | % by wt. | | 20 | | | | | | | | | 20 | |
| Flame retardant, Example 25 | % by wt. | | | 15 | | | | | | | | | |
| Flame retardant, Example 26 | % by wt. | | | | 20 | | | | | | | | 20 |
| Flame retardant, Example 27 | % by wt. | | | | | 30 | | | | | | | |
| Flame retardant, Example 28 | % by wt. | | | | | | 25 | | | | | | |
| Glass fibers 1 | % by wt. | 30 | 30 | 30 | 30 | 30 | 30 | | | | | | |
| Glass fibers 2 | % by wt. | | | | | | | 30 | 30 | 30 | 30 | 30 | 30 |
| Amounts of escaped flame- | g, 2 min | 2.8 | 7.2 | 0.5 | 1.7 | 1.9 | 1.8 | 10.9 | 16.0 | 1.6 | 1.9 | 11.4 | 0.6 |
| retardant polymer molding | | | | | | | | | | | | | |
| composition | | | | | | | | | | | | | |
| Time elapsed prior to escape | sec | 45 | 5 | 52 | 50 | 40 | 41 | 0 | 0 | 50 | 42 | 3 | 55 |
| of flame-retardant polymer | | | | | | | | | | | | | |
| molding composition | | | | | | | | | | | | | |
| UL 94 classification of flame- | — | V-0 | V-0 | V-1 | V-0 | V-0 | V-0 | V-0 | V-0 | V-0 | V-0 | V-0 | V-0 |
| retardant polymer moldings | | | | | | | | | | | | | |

1. A stabilized flame retardant, comprising
a) from 99 to 1% by weight of melamine polyphosphate
b) from 1 to 99% by weight of at least one additive with latent alkalinity.

2. The stabilized flame retardant as claimed in claim 1, comprising
a) from 98 to 75% by weight of melamine polyphosphate
b) from 2 to 25% by weight of the at least one additive with latent alkalinity.

3. The stabilized flame retardant as claimed in claim 1, comprising
a) from 98 to 75% by weight of melamine polyphosphate
b) from 2 to 25% by weight of the at least one additive with latent alkalinity, wherein the at least one additive with latent alkalinity is a.

4. The stabilized flame retardant as claimed in claim 1, further comprising a phosphinic acids, a phosphinic salt or a mixture thereof.

5. The stabilized flame retardant as claimed in claim 4, comprising
a) from 98 to 1% by weight of melamine polyphosphate
b) from 1 to 98% by weight of the at least one additive with latent alkalinity
c) from 1 to 98% by weight of the phosphinic acid. phosphinic salt or mixture thereof.

6. The stabilized flame retardant as claimed in claim 4, comprising
a) from 74 to 25% by weight of melamine polyphosphate
b) from 1 to 10% by weight of the at least one additive with latent alkalinity
c) from 25 to 74% by weight of the phosphinic acid, phosphinic salt or mixture thereof, wherein the phosphinic acid, phosphinic salt or mixture thereof is selected from the group consisting of aluminum trisdiethylphosphinate, aluminum trismethylethylphosphinate, titanyl bisdiethylphosphinate, titanium tetrakisdiethylphosphinate, titanyl bismethylethylphosphinate, titanium tetrakismethylethylphosphinate, zinc bisdiethylphosphinate, and zinc bismethylethylphosphinate.

7. The stabilized flame retardant as claimed in claim 1, wherein the melamine content of the melamine polyphosphate is from 0.9 to 2.0 mol per mole of phosphorus.

8. The stabilized flame retardant as claimed in claim 1, wherein the degree of condensation n of the melamine polyphosphate is from 7 to 200.

9. The stabilized flame retardant as claimed in claim 1, wherein the pH the stabilized flame retardant in a slurry of 10% by weight in water is greater than or equal to 5.

10. The stabilized flame retardant as claimed in claim 1, wherein the latent alkalinity of the at least one additive with latent alkalinity is from 0.5 to 60% by weight.

11. The stabilized flame retardant as claimed in claim 1, wherein the particle size (d₉₀) of the at least one additive with latent alkalinity is from 0.01 to 500 μm.

12. The stabilized flame retardant as claimed in claim 1, further comprising a binder.

13. The stabilized flame retardant as claimed in claim 1, wherein the stabilized flame retardant is a granulated material.

14. The stabilized flame retardant as claimed in claim 1, wherein the stabilized flame retardant is a granulated material, comprising
a) from 98.9 to 70% by weight of melamine polyphosphate
b) from 1 to 30% by weight of the at least one additive with latent alkalinity
c) from 0.1 to 10% by weight of a binder.

15. A process for stabilization of a flame retardant comprising the step of adding
a) from 1 to 99 parts by weight of at least one additive with latent alkalinity to
b) from 99 to 1 parts by weight of melamine polyphosphate.

16. The process as claimed in claim 15, wherein the at least one additive with latent alkalinity and the melamine polyphosphate are mixed at from 0 to 300° C. for from 0.01 to 10 hours in a mixer.

17. A Polymer article comprising a stabilized flame retardant as claimed in claim 1, wherein the polymer article is selected from the group consisting of flame-retardant polymer molding compositions, flame-retardant polymer moldings, flame-retardant polymer films, flame-retardant polymer filaments and flame-retardant polymer fibers.

18. A flame-retardant polymer molding composition, comprising a stabilized flame retardant as claimed in claim 1.

19. The flame-retardant polymer molding composition as claimed in claim 18, comprising
from 1 to 60% by weight of the stabilized flame retardant as claimed in claim 1,
from 1 to 98.5% by weight of a polymer or a mixture of polymers,
from 0.5 to 60% by weight of an additive.

20. A process for production of a flame-retardant polymer molding position as claimed in claim 18, wherein the polymer or mixture of polymers is granulated, comprising the steps of homogenizing the stabilized flame retardant in a compounding assembly at relatively high temperatures with the polymer or mixture of polymers and the additive to form a homogenized polymer strand, drawing off and cooling the homogenized polymer strand and dividing the homogenized polymer strands into portions.

21. A flame-retardant polymer molding composition made in accordance with the process as claimed in claim 18.

22. A flame-retardant polymer molding, flame-retardant polymer film, flame-retardant polymer filament, or flame-retardant polymer fiber, comprising a stabilized flame retardant as claimed in at claim 1.

23. The flame-retardant polymer molding, flame-retardant polymer film, flame-retardant polymer filament, or flame-retardant polymer fiber, as claimed in claim 22, comprising
from 1 to 60% by weight of the stabilized flame retardant
from 1 to 98.5% by weight of a polymer or a mixture of polymers, and
from 0.5 to 60% by weight of additive.

24. A flame-retardant polymer molding, flame-retardant polymer film, flame-retardant polymer filament, or flame-retardant polymer fiber, comprising the flame-retardant polymer molding composition as claimed in claim 18.

25. The flame-retardant polymer molding, flame-retardant polymer film, flame-retardant polymer filament, or flame-retardant polymer fiber as claimed in claim 24, comprising
from 60 to 99% by weight of the flame-retardant polymer molding composition
from 1 to 40% by weight of polymer or a mixture of polymers.

26. A process for production of flame-retardant polymer moldings, of flame-retardant polymer films, of flame-retardant polymer filaments, or of flame-retardant polymer fibers, comprising the steps of processing a flame-retardant polymer molding composition as claimed in claim 18 via at least one of injection molding, compression molding, foam injection molding, internal-gas-pressure injection molding, blow molding, cast-film processes, calendering, lamination, or coating at relatively high temperatures to form a flame-retardant polymer molding, flame-retardant polymer film, flame-retardant polymer filament or flame-retardant polymer fiber.

27. The stabilized flame retardant as claimed in claim 3 wherein the zinc compound is selected from the group consisting of zinc oxide, zinc hydroxide, zinc oxide hydrate, zinc carbonate, zinc stannate, zinc hydroxystannate, basic zinc silicate and mixtures thereof.

28. The stabilized flame retardant as claimed in claim 1, wherein the degree of condensation n of the melamine polyphosphate is from 15 to 150.

29. The stabilized flame retardant as claimed in claim 1, wherein the latent alkalinity of the at least one additive with latent alkalinity is from 1 to 5% by weight.

30. The stabilized flame retardant as claimed in claim 1, wherein the particle size (d₉₀) of the at least one additive with latent alkalinity is from 1 to 50 μm.

31. A polymer article comprising the flame-retardant polymer molding composition as claimed in claim 21, wherein the polymer article is selected from the group consisting of flame-retardant polymer moldings, flame-retardant polymer films, flame-retardant polymer filaments and flame-retardant polymer fibers.
